(19) United States
(12) Patent Application Publication
(10) Pub. No.: US 2026/0304409 A1
(43) Pub. Date: Oct. 1, 2026

(54) CROSS LINK INTERFERENCE RESOURCE SIGNALING

(71) Applicant: QUALCOMM Incorporated, San Diego, CA (US)

(72) Inventors: Qian ZHANG, Basking Ridge, NJ (US); Muhammad Sayed Khairy ABDELGHAFFAR, San Jose, CA (US)

(21) Appl. No.: 19/092,406

(22) Filed: Mar. 27, 2025

(51) Int. Cl. H04W 72/0457; H04B 17/309; H04B 17/318; H04L 5/14

(52) U.S. Cl. CPC H04W 72/0457; H04B 17/328; H04B 17/346; H04L 5/14

(57) ABSTRACT

Various aspects of the present disclosure generally relate to wireless communication. In some aspects, a user equipment (UE) may receive configuration information that comprises a first configuration or a second configuration. The first configuration configures the UE to receive downlink communications via sub-band full duplex (SBFD) symbols or non-SBFD symbols. The second configuration configures the UE to receive downlink communications via the SBFD and the non-SBFD symbols. The UE may receive the downlink communications in accordance with the configuration information. The UE applies the first configuration or the second configuration, or refrains from applying the configuration information to cross link interference received signal strength indicator (CLI-RSSI) measurement resources and sounding reference signal reference signal received power (SRS-RSRP) measurement resources. The UE performs one or more measurements on a signal transmitted via the SBFD symbols, the non-SBFD symbols, or both the SBFD and the non-SBFD symbols. Numerous other aspects are described.

### FIELD OF THE DISCLOSURE

Aspects of the present disclosure generally relate to wireless communication and specifically relate to techniques, apparatuses, and methods associated with cross link interference resource signaling.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

Sub-band full-duplex (SBFD) communication, which may also be referred to as “sub-band frequency division duplex (SBFDD)” or “flexible duplex,” in a wireless communication network refers to simultaneous bi-directions communication between devices in the wireless communication network on the same time resources but different frequency resources. For example, in SBFD, a user equipment may transmit an uplink communication to a network node and receive a downlink communication from the network node at the same time, but on different frequency resources. For example, the different frequency resources may be sub-bands of a frequency band, such as a time division duplexing band. In this case, the frequency resources used for downlink communication may be separated from the frequency resources used for uplink communication, in the frequency domain, by a guard band.

### SUMMARY

Some aspects described herein relate to a method of wireless communication performed by a user equipment (UE). The method may include receiving configuration information associated with a downlink bandwidth part (BWP), wherein the configuration information comprises a first configuration or a second configuration, wherein the first configuration configures the UE to receive downlink communications via only sub-band full duplex (SBFD) symbols of the downlink BWP or only non-SBFD symbols of the downlink BWP, and wherein the second configuration configures the UE to receive the downlink communications via the SBFD symbols and the non-SBFD symbols. The method may include receiving the downlink communications via the downlink BWP in accordance with the configuration information, wherein the UE applies the first configuration or the second configuration, or refrains from applying the configuration information to cross link interference received signal strength indicator (CLI-RSSI) measurement resources and sounding reference signal reference signal received power (SRS-RSRP) measurement resources within the downlink BWP, and wherein the UE performs a CLI-RSSI measurement, an SRS-RSRP measurement, or both the CLI-RSSI measurement and the SRS-RSRP measurement based at least in part on a signal transmitted via the SBFD symbols, the non-SBFD symbols, or both the SBFD symbols and the non-SBFD symbols.

Some aspects described herein relate to a method of wireless communication performed by a UE. The method may include receiving configuration information associated with a downlink BWP, wherein the BWP includes a set of SBFD symbols and a set of non-SBFD symbols. The method may include communicating via the BWP, wherein communications via the downlink BWP are communicated via the set of SBFD symbols or the set of non-SBFD symbols, wherein the UE performs a CLI-RSSI measurement, an SRS-RSRP measurement, or both the CLI-RSSI measurement and the SRS-RSRP measurement.

Some aspects described herein relate to a method of wireless communication performed by a network node. The method may include transmitting configuration information associated with a downlink BWP, wherein the configuration information comprises a first configuration or a second configuration, wherein the first configuration configures a UE to receive downlink communications via only SBFD symbols of the downlink BWP or only non-SBFD symbols of the downlink BWP, wherein the second configuration configures the UE to receive the downlink communications via the SBFD symbols and the non-SBFD symbols, and wherein the configuration information configures the UE to refrain from applying the configuration information to CLI-RSSI measurement resources and SRS-RSRP measurement resources within the downlink BWP. The method may include transmitting the downlink communications via the downlink BWP in accordance with the configuration information.

Some aspects described herein relate to a method of wireless communication performed by a network node. The method may include transmitting configuration information associated with BWP, wherein the BWP includes a set of SBFD symbols and a set of non-SBFD symbols. The method may include communicating with a UE via the BWP, wherein communications via the BWP are communicated via the set of SBFD symbols or the set of non-SBFD symbols in accordance with a condition, wherein the condition is not applied to CLI-RSSI measurement resources and SRS-RSRP measurement resources within the downlink BWP.

Some aspects described herein relate to a non-transitory computer-readable medium that stores a set of instructions for wireless communication by a UE. The set of instructions, when executed by one or more processors of the UE, may cause the UE to receive configuration information associated with a downlink BWP, wherein the configuration information comprises a first configuration or a second configuration, wherein the first configuration configures the UE to receive downlink communications via only SBFD symbols of the downlink BWP or only non-SBFD symbols of the downlink BWP, and wherein the second configuration configures the UE to receive the downlink communications via the SBFD symbols and the non-SBFD symbols. The set of instructions, when executed by one or more processors of the UE, may cause the UE to receive the downlink communications via the downlink BWP in accordance with the configuration information, wherein the UE applies the first configuration or the second configuration or refrains from applying the configuration information to CLI-RSSI measurement resources and SRS-RSRP measurement resources within the downlink BWP, and wherein the UE performs a CLI-RSSI measurement, an SRS-RSRP measurement, or both the CLI-RSSI measurement and the SRS-RSRP measurement based at least in part on a signal transmitted via the SBFD symbols, the non-SBFD symbols, or both the SBFD symbols and the non-SBFD symbols.

Some aspects described herein relate to a non-transitory computer-readable medium that stores a set of instructions for wireless communication by a UE. The set of instructions, when executed by one or more processors of the UE, may cause the UE to receive configuration information associated with a downlink BWP, wherein the BWP includes a set of SBFD symbols and a set of non-SBFD symbols. The set of instructions, when executed by one or more processors of the UE, may cause the UE to communicate via the BWP, wherein communications via the downlink BWP are communicated via the set of SBFD symbols or the set of non-SBFD symbols, wherein the UE performs a CLI-RSSI measurement, an SRS-RSRP measurement, or both the CLI-RSSI measurement and the SRS-RSRP measurement.

Some aspects described herein relate to a non-transitory computer-readable medium that stores a set of instructions for wireless communication by a network node. The set of instructions, when executed by one or more processors of the network node, may cause the network node to transmit configuration information associated with a downlink BWP, wherein the configuration information comprises a first configuration or a second configuration, wherein the first configuration configures a UE to receive downlink communications via only SBFD symbols of the downlink BWP or only non-SBFD symbols of the downlink BWP, wherein the second configuration configures the UE to receive the downlink communications via the SBFD symbols and the non-SBFD symbols, and wherein the configuration information configures the UE to refrain from applying the configuration information to CLI-RSSI measurement resources and SRS-RSRP measurement resources within the downlink BWP. The set of instructions, when executed by one or more processors of the network node, may cause the network node to transmit the downlink communications via the downlink BWP in accordance with the configuration information.

Some aspects described herein relate to a non-transitory computer-readable medium that stores a set of instructions for wireless communication by a network node. The set of instructions, when executed by one or more processors of the network node, may cause the network node to transmit configuration information associated with a downlink BWP, wherein the downlink BWP includes a set of SBFD symbols and a set of non-SBFD symbols. The set of instructions, when executed by one or more processors of the network node, may cause the network node to communicate with a UE via the BWP, wherein communications via the BWP are communicated via the set of SBFD symbols or the set of non-SBFD symbols in accordance with a condition, wherein the condition is not applied to CLI-RSSI measurement resources and SRS-RSRP measurement resources within the downlink BWP.

Some aspects described herein relate to a UE. The UE may include a processing system. The processing system may include one or more processors and one or more code-storing memories coupled with the one or more processors. The processing system may be configured to cause the UE to receive configuration information associated with a downlink BWP, wherein the configuration information comprises a first configuration or a second configuration, wherein the first configuration configures the UE to receive downlink communications via only SBFD symbols of the downlink BWP or only non-SBFD symbols of the downlink BWP, and wherein the second configuration configures the UE to receive the downlink communications via the SBFD symbols and the non-SBFD symbols. The processing system may be configured to cause the UE to receive the downlink communications via the downlink BWP in accordance with the configuration information, wherein the UE applies the first configuration or the second configuration or refrains from applying the configuration information to CLI-RSSI measurement resources and SRS-RSRP measurement resources within the downlink BWP, and wherein the UE performs a CLI-RSSI measurement, an SRS-RSRP measurement, or both the CLI-RSSI measurement and the SRS-RSRP measurement based at least in part on a signal transmitted via the SBFD symbols, the non-SBFD symbols, or both the SBFD symbols and the non-SBFD symbols.

Some aspects described herein relate to a UE. The UE may include a processing system. The processing system may include one or more processors and one or more code-storing memories coupled with the one or more processors. The processing system may be configured to cause the UE to receive configuration information associated with a downlink BWP, wherein the BWP includes a set of SBFD symbols and a set of non-SBFD symbols. The processing system may be configured to cause the UE to communicate via the BWP, wherein communications via the downlink BWP are communicated via the set of SBFD symbols or the set of non-SBFD symbols, wherein the UE performs a CLI-RSSI measurement, an SRS-RSRP measurement, or both the CLI-RSSI measurement and the SRS-RSRP measurement.

Some aspects described herein relate to a network node. The network node may include a processing system. The processing system may include one or more processors and one or more code-storing memories coupled with the one or more processors. The processing system may be configured to cause the network node to transmit configuration information associated with a downlink BWP, wherein the configuration information comprises a first configuration or a second configuration, wherein the first configuration configures a UE to receive downlink communications via only SBFD symbols of the downlink BWP or only non-SBFD symbols of the downlink BWP, wherein the second configuration configures the UE to receive the downlink communications via the SBFD symbols and the non-SBFD symbols, and wherein the configuration information configures the UE to refrain from applying the configuration information to CLI-RSSI measurement resources and SRS-RSRP measurement resources within the downlink BWP. The processing system may be configured to cause the network node to transmit the downlink communications via the downlink BWP in accordance with the configuration information.

Some aspects described herein relate to a network node. The network node may include a processing system. The processing system may include one or more processors and one or more code-storing memories coupled with the one or more processors. The processing system may be configured to cause the network node to transmit configuration information associated with a downlink BWP, wherein the BWP includes a set of SBFD symbols and a set of non-SBFD symbols. The processing system may be configured to cause the network node to communicate with a UE via the BWP, wherein communications via the BWP are communicated via the set of SBFD symbols or the set of non-SBFD symbols in accordance with a condition, wherein the condition is not applied to CLI-RSSI measurement resources and SRS-RSRP measurement resources within the downlink BWP.

Some aspects described herein relate to an apparatus for wireless communication. The apparatus may include means for receiving configuration information associated with a downlink BWP, wherein the configuration information comprises a first configuration or a second configuration, wherein the first configuration configures the apparatus to receive downlink communications via only SBFD symbols of the downlink BWP or only non-SBFD symbols of the downlink BWP, and wherein the second configuration configures the apparatus to receive the downlink communications via the SBFD symbols and the non-SBFD symbols. The apparatus may include means for receiving the downlink communications via the downlink BWP in accordance with the configuration information, wherein the apparatus applies the first configuration or the second configuration or refrains from applying the configuration information to CLI-RSSI measurement resources and SRS-RSRP measurement resources within the downlink BWP, and wherein the apparatus performs a CLI-RSSI measurement, an SRS-RSRP measurement, or both the CLI-RSSI measurement and the SRS-RSRP measurement based at least in part on a signal transmitted via the SBFD symbols, the non-SBFD symbols, or both the SBFD symbols and the non-SBFD symbols.

Some aspects described herein relate to an apparatus for wireless communication. The apparatus may include means for receiving configuration information associated with a downlink BWP, wherein the downlink BWP includes a set of SBFD symbols and a set of non-SBFD symbols. The apparatus may include means for communicating via the downlink BWP, wherein communications via the downlink BWP are communicated via the set of SBFD symbols or the set of non-SBFD symbols, wherein the apparatus performs a CLI-RSSI measurement, an SRS-RSRP measurement, or both the CLI-RSSI measurement and the SRS-RSRP measurement.

Some aspects described herein relate to an apparatus for wireless communication. The apparatus may include means for transmitting configuration information associated with a downlink BWP, wherein the configuration information comprises a first configuration or a second configuration, wherein the first configuration configures a UE to receive downlink communications via only SBFD symbols of the downlink BWP or only non-SBFD symbols of the downlink BWP, wherein the second configuration configures the UE to receive the downlink communications via the SBFD symbols and the non-SBFD symbols, and wherein the configuration information configures the UE to refrain from applying the configuration information to CLI-RSSI measurement resources and SRS-RSRP measurement resources within the downlink BWP. The apparatus may include means for transmitting the downlink communications via the downlink BWP in accordance with the configuration information.

Some aspects described herein relate to an apparatus for wireless communication. The apparatus may include means for transmitting configuration information associated with a downlink BWP, wherein the downlink BWP includes a set of SBFD symbols and a set of non-SBFD symbols. The apparatus may include means for communicating with a UE via the downlink BWP, wherein communications via the downlink BWP are communicated via the set of SBFD symbols or the set of non-SBFD symbols in accordance with a condition, wherein the condition is not applied to CLI-RSSI measurement resources and SRS-RSRP measurement resources within the downlink BWP.

The systems, methods, and devices of this disclosure each have several innovative aspects, no single one of which is solely responsible for the desirable attributes disclosed herein.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a diagram illustrating an example of a wireless communication network.

FIG. 2 is a diagram illustrating examples of full-duplex communication in a wireless communication network.

FIG. 3 is a diagram illustrating an example relating to cross-link interference (CLI) detection and mitigation.

FIG. 4 is a diagram illustrating an example associated with CLI resource signaling.

FIG. 5 is a diagram illustrating an example process performed, for example, at a user equipment (UE) or an apparatus of a UE.

FIG. 6 is a diagram illustrating an example process performed, for example, at a UE or an apparatus of a UE.

FIG. 7 is a diagram illustrating an example process performed, for example, at a network node or an apparatus of a network node.

FIG. 8 is a diagram illustrating an example process performed, for example, at a network node or an apparatus of a network node.

FIG. 9 is a diagram of an example apparatus for wireless communication.

FIG. 10 is a diagram of an example apparatus for wireless communication.

### DETAILED DESCRIPTION

A network entity (e.g., network node) may communicate with a user equipment (UE) using sub-band full-duplex (SBFD) communication. The UE may transmit an uplink communication to the network entity and another UE may receive a downlink communication from the network entity at the same time, but on different frequency resources. However, this may introduce inter-UE cross-link interference (CLI). This may be an issue when a UE is measuring reference signals and transmitting beam reports.

In some cases, to mitigate CLI, interference levels between UEs within the same cell or across different cells may be measured and reported. However, for uplink transmissions and downlink receptions across SBFD symbols and non-SBFD symbols in different slots, a UE may be unable to determine whether interference levels are to be measured based on signals transmitted via SBFD symbols, non-SBFD symbols, or both SBFD symbols and non-SBFD symbols.

Various aspects relate generally to CLI interference signaling for SBFD communications. Some aspects more specifically relate to receiving configuration information for a downlink bandwidth part (BWP). The configuration information may be associated with a first configuration that configures a UE to receive downlink communications via only SBFD or only non-SBFD symbols of the downlink BWP, or a second configuration that configures the UE to receive the downlink communications via both the SBFD symbols and the non-SBFD symbols. In some aspects, the UE may receive downlink communications via the downlink BWP in accordance with the configuration information.

In some aspects, the UE applies the first configuration or the second configuration, or refrains from applying the configuration information to CLI received signal strength indicator (CLI-RSSI) measurement resources and sounding reference signal reference signal received power (SRS-RSRP) measurement resources within the downlink BWP. In some aspects, the UE performs a CLI-RSSI measurement, an SRS-RSRP measurement, or both the CLI-RSSI measurement and the SRS-RSRP measurement based at least in part on a signal transmitted via the SBFD symbols, the non-SBFD symbols, or both the SBFD symbols and the non-SBFD symbols.

Particular aspects of the subject matter described in this disclosure can be implemented to realize one or more of the following potential advantages. In some examples, the described techniques can be used to measure and report CLI associated with SBFD communications. By providing CLI information, the UE may assist the network entity with determining whether the UE is experiencing a low RSRP or a low signal-to-interference-plus-noise ratio (SINR) because of inter-UE CLI. The network entity may adjust SBFD scheduling to mitigate the effect of inter-UE CLI. As a result, communications may improve, which conserves signaling resources, reduces latency, and improves throughput.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

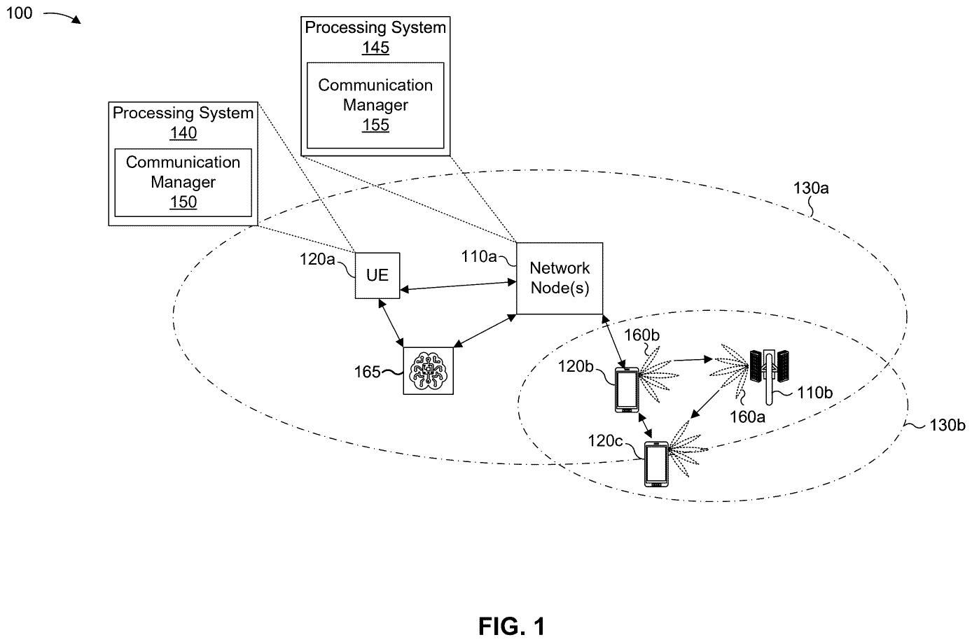

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHZ), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHZ), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A CU can communicate with a core network either directly (for example, via a backhaul link) or indirectly (for example, via one or more disaggregated control units, such as a non-real-time (Non-RT) RAN intelligent controller (RIC) associated with a Service Management and Orchestration (SMO) framework or a near-real-time (Near-RT) RIC). A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. A CU may communicate with one or more DUs via respective midhaul links, such as via F1 interfaces. Each of the DUs may communicate with one or more RUs via respective fronthaul links. Each of the RUs may communicate with one or more UEs 120 via respective RF access links. In some deployments, a UE 120 may be simultaneously served by multiple RUs.

In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment (for example, an open cloud (O-Cloud) platform). An SMO framework may support RAN deployment and provisioning of non-virtualized and virtualized network elements.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (L1), a rank indicator (RI), or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

A network node 110 and a UE 120 may communicate in a half-duplex mode or a full-duplex mode. A network node 110 or a UE 120 operating in a half-duplex mode may perform only one of transmission or reception during particular time resources, such as during particular slots, symbols, or other time periods. In various examples, some of the network nodes 110 and the UEs 120 of the wireless communication network 100 may be configured for full-duplex operation in addition to half-duplex operation. In full-duplex operation, a network node 110 or a UE 120 operating in a full-duplex (for example, SBFD) mode can transmit and receive communications concurrently (for example, in the same time resources). For example, as shown in FIG. 1, the network node 110b may operate in the full-duplex mode. The network node 110b may concurrently receive uplink communications from the UE 120b and transmit downlink communications to the UE 120c. By operating in a full-duplex mode, network nodes 110 or UEs 120 may generally increase the capacity of the network and the radio access link. In some examples, full-duplex operation may involve FDD, in which downlink transmissions of the network node 110b are performed in a first frequency band or on a first component carrier and transmissions of the UE 120b are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an uplink transmission to a first network node 110 and receive a downlink transmission from a second network node 110 in the same time resources. In some other examples, full-duplex operation may be enabled for a network node 110 but not for a UE 120. For example, the network node 110b may simultaneously transmit a downlink transmission to a first UE 120 (for example, the UE 120c) and receive an uplink transmission from a second UE 120 (for example, the UE 120b) in the same time resources. In some other examples, full-duplex operation may be enabled for both a network node 110 and a UE 120.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples).

In some aspects, a UE 120 may include a communication manager 150. As described in more detail elsewhere herein, the communication manager 150 may receive configuration information associated with a downlink BWP, wherein the configuration information comprises a first configuration or a second configuration, wherein the first configuration configures the UE to receive downlink communications via only SBFD symbols of the downlink BWP or only non-SBFD symbols of the downlink BWP, and wherein the second configuration configures the UE to receive the downlink communications via the SBFD symbols and the non-SBFD symbols; and receive the downlink communications via the downlink BWP in accordance with the configuration information, wherein the UE applies the first configuration or the second configuration, or refrains from applying the configuration information to CLI-RSSI measurement resources and SRS-RSRP measurement resources within the downlink BWP, and wherein the UE performs a CLI-RSSI measurement, an SRS-RSRP measurement, or both the CLI-RSSI measurement and the SRS-RSRP measurement based at least in part on a signal transmitted via the SBFD symbols, the non-SBFD symbols, or both the SBFD symbols and the non-SBFD symbols.

In some aspects, the communication manager 150 may receive configuration information associated with a downlink BWP, wherein the downlink BWP includes a set of SBFD symbols and a set of non-SBFD symbols; and communicate via the downlink BWP, wherein communications via the downlink BWP are communicated via the set of SBFD symbols or the set of non-SBFD symbols, wherein the UE performs a CLI-RSSI measurement, an SRS-RSRP measurement, or both the CLI-RSSI measurement and the SRS-RSRP measurement. Additionally, or alternatively, the communication manager 150 may perform one or more other operations described herein.

In some aspects, a network node 110 may include a communication manager 155. As described in more detail elsewhere herein, the communication manager 155 may transmit configuration information associated with a downlink BWP, wherein the configuration information comprises a first configuration or a second configuration, wherein the first configuration configures a UE to receive downlink communications via only SBFD symbols of the downlink BWP or only non-SBFD symbols of the downlink BWP, wherein the second configuration configures the UE to receive the downlink communications via the SBFD symbols and the non-SBFD symbols, and wherein the configuration information configures the UE to refrain from applying the configuration information to CLI-RSSI measurement resources and SRS-RSRP measurement resources within the downlink BWP; and transmit the downlink communications via the downlink BWP in accordance with the configuration information.

In some aspects, the communication manager 155 may transmit configuration information associated with a downlink BWP, wherein the BWP includes a set of SBFD symbols and a set of non-SBFD symbols; and communicate with a UE via the downlink BWP, wherein communications via the downlink BWP are communicated via the set of SBFD symbols or the set of non-SBFD symbols in accordance with a condition, wherein the condition is not applied to CLI-RSSI measurement resources and SRS-RSRP measurement resources within the downlink BWP. Additionally, or alternatively, the communication manager 155 may perform one or more other operations described herein.

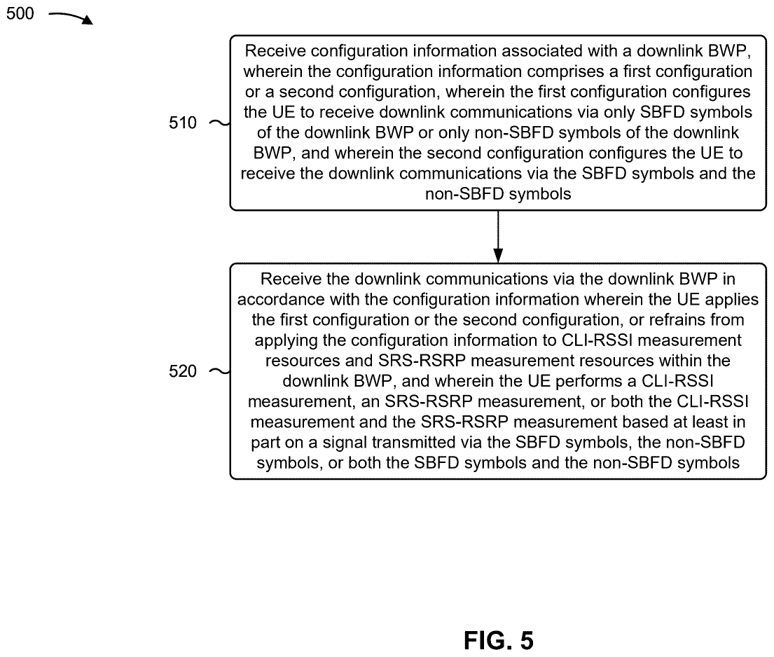

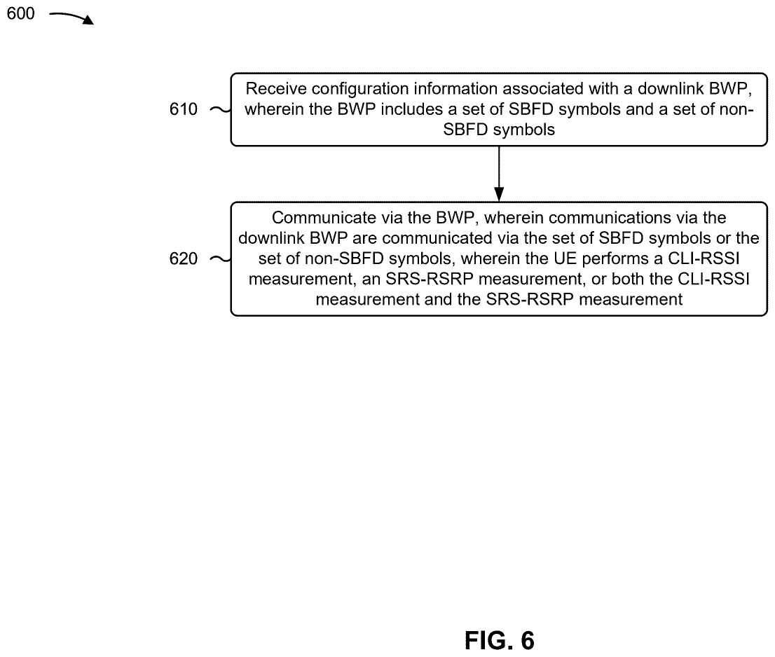

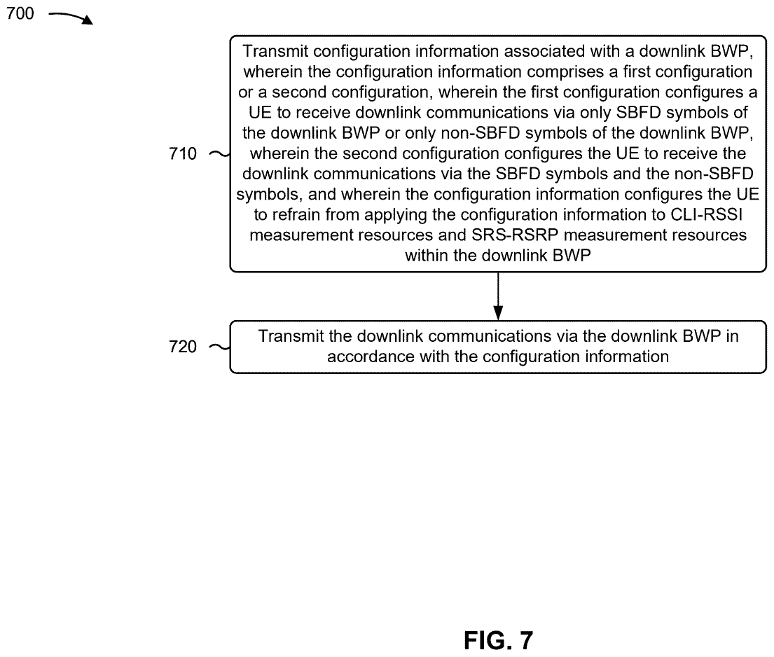

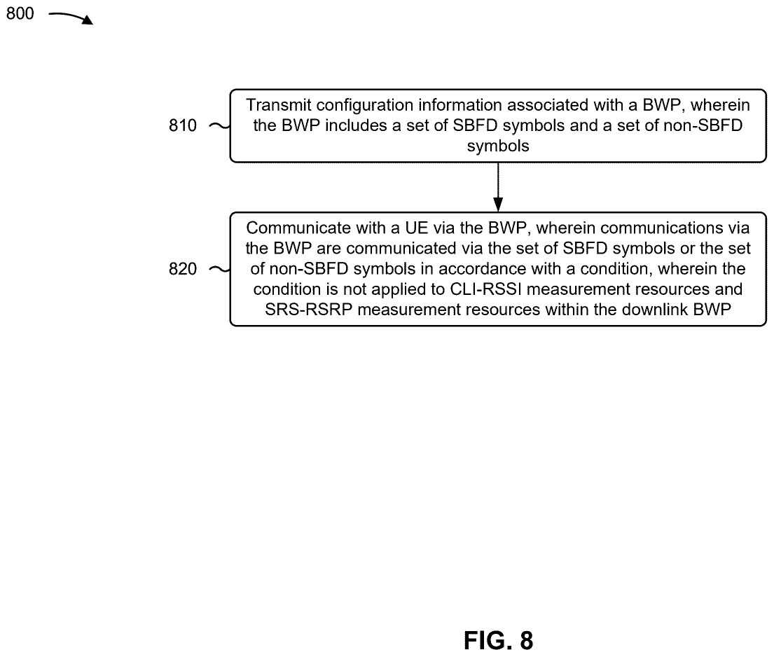

The network node 110, the processing system 145 of the network node 110, the UE 120, the processing system 140 of the UE 120, or any other component(s) of FIG. 1 may implement one or more techniques or perform one or more operations associated with CLI resource signaling, as described in more detail elsewhere herein. For example, the processing system 145 of the network node 110, or the processing system 140 of the UE 120 may perform or direct operations of, for example, process 500 of FIG. 5, process 600 of FIG. 6, process 700 of FIG. 7, process 800 of FIG. 8, or other processes as described herein (alone or in conjunction with one or more other processors). Memory of the network node 110 may store data and program code (or instructions) for the network node 110. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, or the UE 120, may cause the one or more processors to perform process 500 of FIG. 5, process 600 of FIG. 6, process 700 of FIG. 7, process 800 of FIG. 8, or other processes as described herein. In some examples, executing instructions may include running the instructions, converting the instructions, compiling the instructions, or interpreting the instructions, among other examples.

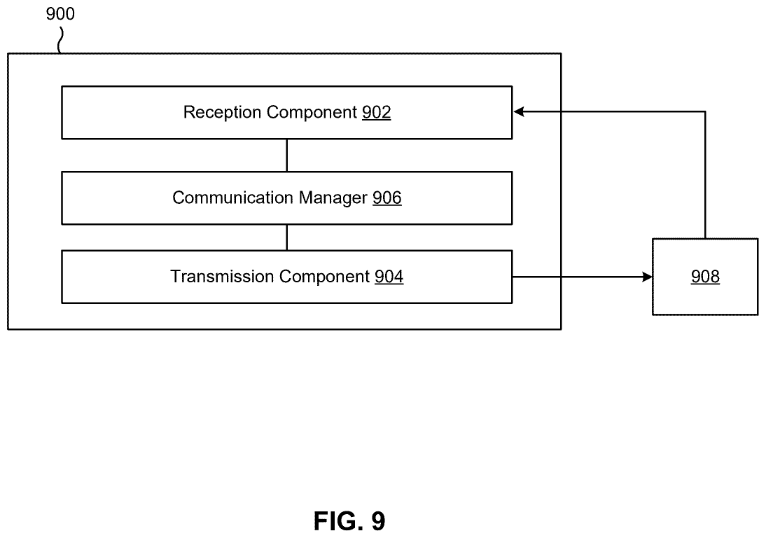

In some aspects, a UE includes means for receiving configuration information associated with a downlink BWP, wherein the configuration information comprises a first configuration or a second configuration, wherein the first configuration configures the UE to receive downlink communications via only SBFD symbols of the downlink BWP or only non-SBFD symbols of the downlink BWP, and wherein the second configuration configures the UE to receive the downlink communications via the SBFD symbols and the non-SBFD symbols; or means for receiving the downlink communications via the downlink BWP in accordance with the configuration information, wherein the UE applies the first configuration or the second configuration, or refrains from applying the configuration information to CLI-RSSI measurement resources and SRS-RSRP measurement resources within the downlink BWP, and wherein the UE performs a CLI-RSSI measurement, an SRS-RSRP measurement, or both the CLI-RSSI measurement and the SRS-RSRP measurement based at least in part on a signal transmitted via the SBFD symbols, the non-SBFD symbols, or both the SBFD symbols and the non-SBFD symbols. The means for the UE to perform operations described herein may include, for example, one or more of communication manager 150, processing system 140, a radio, one or more RF chains, one or more transceivers, one or more antennas, one or more modems, a reception component (for example, reception component 902 depicted and described in connection with FIG. 9), or a transmission component (for example, transmission component 904 depicted and described in connection with FIG. 9), among other examples.

In some aspects, a UE includes means for receiving configuration information associated with a downlink BWP, wherein the downlink BWP includes a set of SBFD symbols and a set of non-SBFD symbols; or means for communicating via the downlink BWP, wherein communications via the downlink BWP are communicated via the set of SBFD symbols or the set of non-SBFD symbols, wherein the UE performs a CLI-RSSI measurement, an SRS-RSRP measurement, or both the CLI-RSSI measurement and the SRS-RSRP measurement. The means for the UE to perform operations described herein may include, for example, one or more of communication manager 150, processing system 140, a radio, one or more RF chains, one or more transceivers, one or more antennas, one or more modems, a reception component (for example, reception component 902 depicted and described in connection with FIG. 9), or a transmission component (for example, transmission component 904 depicted and described in connection with FIG. 9), among other examples.

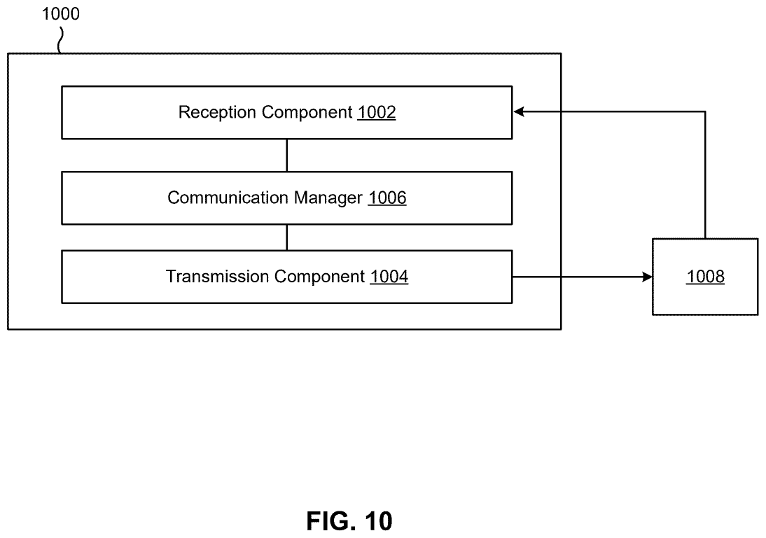

In some aspects, a network node includes means for transmitting configuration information associated with a downlink BWP, wherein the configuration information comprises a first configuration or a second configuration, wherein the first configuration configures a UE to receive downlink communications via only SBFD symbols of the downlink BWP or only non-SBFD symbols of the downlink BWP, wherein the second configuration configures the UE to receive the downlink communications via the SBFD symbols and the non-SBFD symbols, and wherein the configuration information configures the UE to refrain from applying the configuration information to CLI-RSSI measurement resources and SRS-RSRP measurement resources within the downlink BWP; or means for transmitting the downlink communications via the downlink BWP in accordance with the configuration information. The means for the network node to perform operations described herein may include, for example, one or more of communication manager 155, processing system 145, a radio, one or more RF chains, one or more transceivers, one or more antennas, one or more modems, a reception component (for example, reception component 1002 depicted and described in connection with FIG. 10), or a transmission component (for example, transmission component 1004 depicted and described in connection with FIG. 10), among other examples.

In some aspects, a network node includes means for transmitting configuration information associated with downlink BWP, wherein the downlink BWP includes a set of SBFD symbols and a set of non-SBFD symbols; or means for communicating with a UE via the BWP, wherein communications via the BWP are communicated via the set of SBFD symbols or the set of non-SBFD symbols in accordance with a condition, wherein the condition is not applied to CLI-RSSI measurement resources and SRS-RSRP measurement resources within the downlink BWP. The means for the network node to perform operations described herein may include, for example, one or more of communication manager 155, processing system 145, a radio, one or more RF chains, one or more transceivers, one or more antennas, one or more modems, a reception component (for example, reception component 1002 depicted and described in connection with FIG. 10), or a transmission component (for example, transmission component 1004 depicted and described in connection with FIG. 10), among other examples.

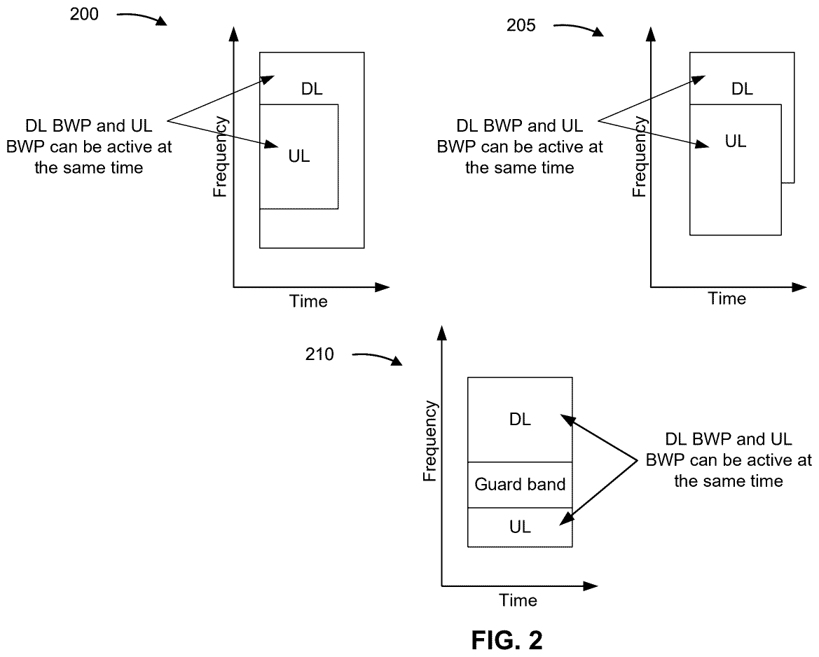

FIG. 2 is a diagram illustrating examples 200, 205, and 210 of full-duplex communication in a wireless communication network. “Full-duplex communication” in a wireless communication network refers to simultaneous bi-directional communication between devices in the wireless communication network. For example, a UE operating in a full-duplex mode may transmit an uplink communication and receive a downlink communication at the same time (e.g., in the same slot or the same symbol). “Half-duplex communication” in a wireless communication network refers to unidirectional communications (e.g., only downlink communication or only uplink communication) between devices at a given time (e.g., in a given slot or a given symbol).

As shown in FIG. 2, examples 200 and 205 show examples of in-band full-duplex (IBFD) communication. In IBFD, a UE may transmit an uplink communication to a network node and receive a downlink communication from the network node on the same time and frequency resources. As shown in example 200, in a first example of IBFD, the time and frequency resources for uplink communication may fully overlap with the time and frequency resources for downlink communication. As shown in example 205, in a second example of IBFD, the time and frequency resources for uplink communication may partially overlap with the time and frequency resources for downlink communication.

As further shown in FIG. 2, example 210 shows an example of SBFD communication. In SBFD, a UE may transmit an uplink communication to a network node and receive a downlink communication from the network node at the same time, but on different frequency resources. For example, the different frequency resources may be sub-bands of a frequency band, such as a time division duplexing band. In this case, the frequency resources used for downlink communication may be separated from the frequency resources used for uplink communication, in the frequency domain, by a guard band.

As indicated above, FIG. 2 is provided as an example. Other examples may differ from what is described with respect to FIG. 2.

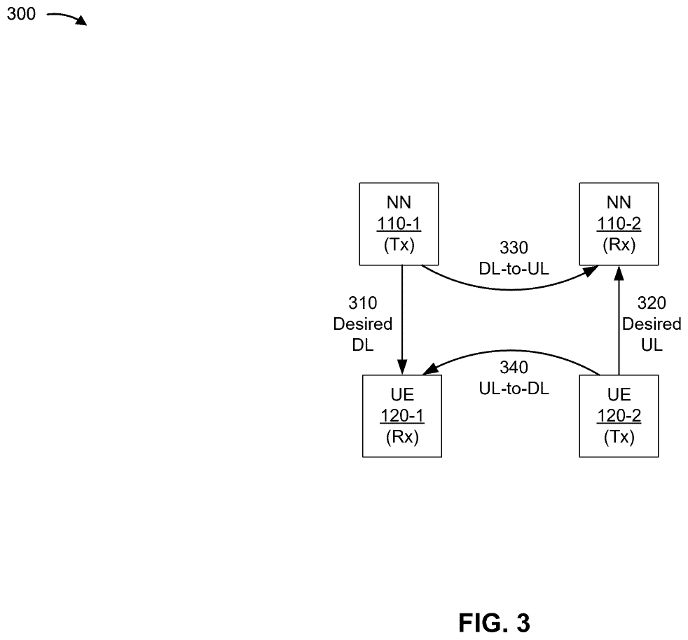

FIG. 3 is a diagram illustrating an example 300 relating to cross-link interference detection and mitigation.

In dynamic TDD, the allocation of network resources to uplink and downlink may be dynamically modified depending on a traffic load. For example, a network node 110 may configure a TDD configuration (e.g., a TDD pattern) with more uplink TTIs (e.g., frames, subframes, slots, mini-slots, or symbols) for a UE 120 when the UE 120 has uplink data to transmit, and may configure a TDD configuration with more downlink TTIs for the UE 120 when the UE 120 has downlink data to receive. The TDD configuration may be dynamically configured to modify the allocation of uplink TTIs and downlink TTIs used for communication between the network node 110 and the UE 120.

As shown in FIG. 3, when neighboring network nodes 110 use different TDD configurations to communicate with UEs 120, this may result in a downlink communication 310 between a first network node 110-1 and a first UE 120-1 in a same TTI as an uplink communication 320 between a second network node 110-2 and a second UE 120-2. These communications in different transmission directions (e.g., downlink vs. uplink) in the same TTI may interfere with one another, which may be referred to as cross-link interference.

For example, as shown by reference number 330, the downlink communication 310 transmitted by the first network node 110-1 may be received by the second network node 110-2, and may interfere with reception, by the second network node 110-2, of the uplink communication 320 from the second UE 120-2. This may be referred to as downlink-to-uplink (DL-to-UL) interference, network node to network node interference, or gNB-to-gNB interference.

Further, as shown by reference number 340, the uplink communication 320 transmitted by the second UE 120-2 may be received by the first UE 120-1, and may interfere with reception, by the first UE 120-1, of the downlink communication 310 from the first network node 110-1. This may be referred to as uplink-to-downlink (UL-to-DL) interference or UE-to-UE interference. This UE to UE interference may occur or may increase when the first UE 120-1 and the second UE 120-2 are in close proximity, and may be avoided or mitigated by preventing scheduling of the UEs 120 in different transmission directions in the same TTI.

As indicated above, FIG. 3 is provided as an example. Other examples are possible and may differ from what was described with respect to FIG. 3.

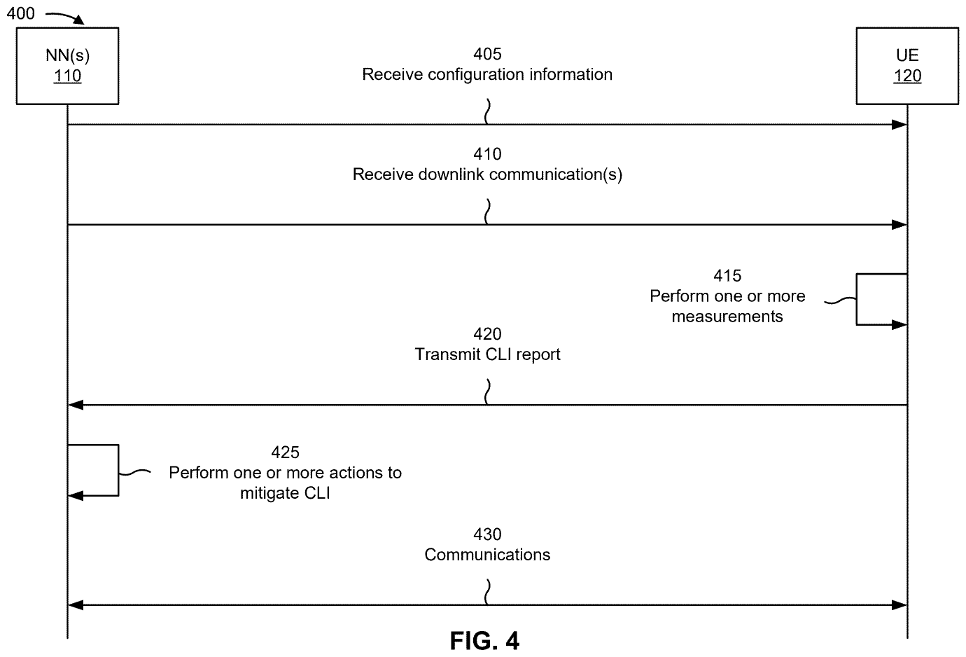

FIG. 4 is a diagram illustrating an example 400 associated with CLI resource signaling. As shown in FIG. 4, a network node 110 and a UE 120 may communicate with one another.

As shown by reference number 405, the network node 110 may transmit, and the UE 120 may receive, configuration information associated with a downlink BWP. In some aspects, the configuration information may be associated with CSI. For example, the configuration information may be included in a CSI-ReportConfig information element.

In some aspects, the configuration information may be a first configuration. The first configuration may configure the UE 120 to receive downlink communications via only SBFD symbols of the downlink BWP or only non-SBFD symbols of the downlink BWP.

In some aspects, the first configuration may be a default configuration. In some aspects, the second configuration may be based at least in part on a capability of the UE 120. For example, the UE 120 may transmit capability information to the network node 110 indicating support for the second configuration. The network node 110 may configure one or more BWPs with the second configuration based at least in part on the UE 120 indicating support for the second configuration. In some aspects, the network node 110 may configure the UE 120 with the second configuration on an uplink and downlink BWP basis.

In some aspects, the configuration information may only apply to PDSCH receptions within the downlink BWP. For example, the configuration information may not apply to PDCCH receptions with the downlink BWP. In some aspects, the configuration information may not apply to one or more signals received within the downlink BWP. For example, the configuration information may not apply to receptions of SRS, CSI-RS, or CLI-RS, among other examples.

In some aspects, the configuration information may not apply to one or more resources within the downlink BWP. For example, the configuration information may not apply to SRS-RSRP measurement resources or CLI-RS measurement resources, among other examples. In some aspects, the configuration information applies to all receptions or all resources within the downlink BWP.

In some aspects, the configuration information may be a second configuration. The second configuration may configure the UE 120 to receive the downlink communications via the SBFD symbols and the non-SBFD symbols.

In some aspects, the configuration information may indicate a valid symbol type associated with resources associated with measuring CLI. For example, the configuration information may include a field that includes data indicating that the valid symbol type corresponds to the SBFD symbols or the non-SBFD symbols. In some aspects, the valid symbol type may be a type of symbol (e.g., an SBFD symbol or a non-SBFD symbol) via which a reference signal (e.g., a CLI-RS or an SRS-RSRP, among other examples) for measuring CLI is transmitted.

In some aspects, the configuration information may indicate a valid symbol type associated with the first configuration. For example, the configuration information may indicate that a valid symbol type for the first configuration corresponds to the SBFD symbols.

In some aspects, the configuration information may indicate a valid symbol type associated with the second configuration. For example, the configuration information may indicate that a valid symbol type for the second configuration corresponds to the non-SBFD symbols.

In some aspects, the field may not be configured (e.g., may not include any data). In these aspects, the UE 120 may determine that the valid symbol type corresponds to the SBFD symbols based at least in part on the field not being configured.

In some aspects, the configuration information may configure a set of CLI measurement resources. In some aspects, the set of CLI measurement resources may be configured across the SBFD symbols, across the non-SBFD symbols, or across both the SBFD symbols and the non-SBFD symbols.

In some aspects, the configuration information may include a CLI report configuration associated with the UE 120 transmitting a CLI report. In some aspects, the CLI report configuration may indicate, configure, or otherwise cause the UE 120 to transmit a CLI report based at least in part on performing one or more measurements on signals transmitted via the set of CLI measurement resources.

In some aspects, the UE 120 may determine that the UE 120 is to receive downlink communications via only the SBFD symbols of the downlink BWP based at least in part on the UE 120 being configured to transmit the CLI report. In some aspects, the UE 120 may determine that the UE 120 is to receive downlink communications via only the non-SBFD symbols of the downlink BWP based at least in part on the UE 120 being configured to transmit the CLI report.

In some aspects, the CLI report configuration may indicate whether an average measured CLI resource value is to be reported by the UE 120. For example, the CLI report configuration may include a timeRestrictionForChannelMeasurement parameter that is set to “configured” to indicate that no average of CLI measurement occasions are to be used for CLI reporting (e.g., that the UE 120 is to refrain from reporting an average measured CLI resource value).

In some aspects, the CLI report configuration may be transmitted separately from the configuration information that configures the set of CLI measurement resources. For example, the network node 110 may transmit, and the UE 120 may receive, first configuration information that configures the set of CLI measurement resources. The network node 110 may transmit, and the UE 120 may receive, second configuration information that includes the CLI report configuration. The second configuration information may be transmitted separately from the first configuration information.

In some aspects, the configuration information may include the first configuration, and the configuration information may omit certain information to indicate whether the UE 120 is to receive the downlink communications via the SBFD symbols or the non-SBFD symbols. For example, information indicating whether the UE 120 is to receive the downlink communications via the SBFD symbols or the non-SBFD symbols may be absent or omitted from the configuration information.

In some aspects, the UE 120 may determine that the downlink communications are received via the SBFD symbols based at least in part on the information indicating whether the UE 120 is to receive the downlink communications via the SBFD symbols or the non-SBFD symbols being absent from the configuration information. In some aspects, the UE 120 may determine that the downlink communications are received via the non-SBFD symbols based at least in part on the information indicating whether the UE 120 is to receive the downlink communications via the SBFD symbols or the non-SBFD symbols being absent from the configuration information.

In some aspects, the configuration information may include the first configuration and may be associated with CSI reporting. In some aspects, information indicating whether the CSI reporting is associated with the SBFD symbols or the non-SBFD symbols may be absent or omitted from the configuration information to indicate whether the CSI reporting is associated with the SBFD symbols or the non-SBFD symbols. In some aspects, the UE 120 may determine that the downlink communications are received via the non-SBFD symbols based at least in part on the information indicating whether the CSI reporting is associated with the SBFD symbols or the non-SBFD symbols being absent or omitted from the configuration information. In some aspects, the UE 120 may determine that the downlink communications are received via the SBFD symbols based at least in part on the information indicating whether the CSI reporting is associated with the SBFD symbols or the non-SBFD symbols being absent or omitted from the configuration information.

As shown by reference number 410, the network node 110 may transmit, and the UE 120 may receive, downlink communications via the downlink BWP. In some aspects, the UE 120 may receive the downlink communications in accordance with the configuration information.

In some aspects, the UE 120 may apply the first configuration or the second configuration, or may refrain from applying the configuration information (e.g., the UE 120 may not apply the first configuration or the second configuration) to CLI-RSSI measurement resources and SRS-RSRP measurement resources.

In some aspects, the configuration information may comprise the first configuration and the UE 120 may receive the downlink communications via only the SBFD symbols or only the non-SBFD symbols of the downlink BWP. In some aspects, the configuration information may comprise the second configuration and the UE 120 may receive the downlink communications via the SBFD symbols and the non-SBFD symbols.

As shown by reference number 415, the UE 120 may perform one or more measurements based at least in part on the downlink communications. In some aspects, the one or more measurements may include a CLI-RSSI measurement, an SRS-RSRP measurement, or both the CLI-RSSI measurement and the SRS-RSRP measurement. In some aspects, the UE 120 may perform the one or more measurements based at least in part on the SBFD symbols. For example, the configuration information may comprise the first configuration information and may indicate that an SBFD symbol corresponds to a valid symbol. The UE 120 may perform the one or more measurements based at least in part on a signal (e.g., a downlink communication) transmitted via the SBFD symbols in accordance with the configuration information (e.g., the first configuration).

In some aspects, the UE 120 may perform the one or more measurements based at least in part on the non-SBFD symbols. For example, the configuration information may comprise the first configuration information and may indicate that a non-SBFD symbol corresponds to a valid symbol. The UE 120 may perform the one or more measurements based at least in part on a signal (e.g., a downlink communication) transmitted via the non-SBFD symbols in accordance with the configuration information (e.g., the first configuration).

In some aspects, the UE 120 may perform the one or more measurements based at least in part on both the SBFD symbols and the non-SBFD symbols. For example, the configuration information may comprise the second configuration information. The UE 120 may perform the one or more measurements based at least in part on a signal (e.g., a downlink communication) transmitted via the SBFD symbols and the non-SBFD symbols in accordance with the configuration information (e.g., the second configuration).

In some aspects, the configuration information may indicate a set of CLI measurement resource occasions. In some aspects, the set of CLI measurement occasions may be in SBFD symbols. In these aspects, the UE 120 may measure CLI based at least in part on a signal transmitted via the SBFD symbols and may refrain from measuring CLI based at least in part on signals transmitted via non-SBFD symbols.

In some aspects, the set of CLI measurement occasions may be in SBFD symbols and non-SBFD symbols. In some aspects, the UE 120 may measure CLI based at least in part on a signal transmitted via the SBFD symbols and may refrain from measuring CLI based at least in part on signals transmitted via the non-SBFD symbols.

In some aspects, the UE 120 may measure CLI based at least in part on a signal transmitted via the non-SBFD symbols and may refrain from measuring CLI based at least in part on signals transmitted via the SBFD symbols. In some aspects, the UE 120 may measure CLI based at least in part on signals transmitted via the SBFD symbols and the non-SBFD symbols. In these aspects, the UE 120 may refrain from averaging CLI measurement results across the SBFD symbols and the non-SBFD symbols.

In some aspects, the UE 120 may determine an average measured CLI resource value based at least in part on performing the one or more measurements. For example, the UE 120 may perform the one or more measurements based at least in part on the SBFD symbols, and the UE 120 may determine an average measured CLI resource value based at least in part on a result of performing the one or more measurements on the SBFD symbols. As another example, the UE 120 may perform the one or more measurements based at least in part on the non-SBFD symbols and the UE 120 may determine an average measured CLI resource value based at least in part on a result of performing the one or more measurements on the non-SBFD symbols.

In some aspects, the UE 120 may not determine (e.g., may refrain from determining) an average measured CLI resource value based at least in part on performing the one or more measurements. In some aspects, CLI measurement resources may be configured across the SBFD symbols and the non-SBFD symbols. In some aspects, the configuration information may comprise the second configuration. In these aspects, the UE 120 may perform the one or more measurements based at least in part on both the SBFD symbols and the non-SBFD symbols. The UE 120 may not determine an average measured CLI resource value based at least in part on a result of performing the one or more measurements on both the SBFD symbols and the non-SBFD symbols.

As shown by reference number 420, the UE 120 may transmit, and the network node 110 may receive, a CLI report based at least in part on the UE 120 performing the one or more measurements.

In some aspects, the UE 120 may measure multiple CLI resource values. In some aspects, the CLI report may indicate a latest measured CLI resource value of the multiple CLI resources values measured by the UE 120. In some aspects, the configuration information may include the second configuration and the CLI report may indicate the latest measure CLI resource value based at least in part on the configuration information including the second configuration.

In some aspects, the set of CLI measurement resources are configured across the SBFD symbols and the non-SBFD symbols. The CLI report may indicate the latest measured CLI resource value based at least in part on the set of CLI measurement resources being configured across the SBFD symbols and the non-SBFD symbols.

As shown by reference number 425, the network node 110 may perform one or more actions to mitigate CLI based at least in part on the CLI report. In some aspects, the one or more actions may include modifying SBFD scheduling for the UE 120. For example, the network node 110 may reconfigure one or more symbols from SBFD symbols to non-SBFD symbols. As another example, the network node 110 may reconfigure one or more non-SBFD symbols to SBFD symbols. In this way, the network node 110 may mitigate CLI for the UE 120.

As shown by reference number 430, the UE 120 and the network node 110 may communicate based at least in part on the one or more actions being performed.

As indicated above, FIG. 4 is provided as an example. Other examples may differ from what is described with respect to FIG. 4.

FIG. 5 is a diagram illustrating an example process 500 performed, for example, at a UE or an apparatus of a UE. Example process 500 is an example where the apparatus or the UE (e.g., UE 120) performs operations associated with CLI resource signaling.

As shown in FIG. 5, in some aspects, process 500 may include receiving configuration information associated with a downlink BWP, wherein the configuration information comprises a first configuration or a second configuration, wherein the first configuration configures the UE to receive downlink communications via only SBFD symbols of the downlink BWP or only non-SBFD symbols of the downlink BWP, and wherein the second configuration configures the UE to receive the downlink communications via the SBFD symbols and the non-SBFD symbols (block 510). For example, the UE (e.g., using reception component 902 or communication manager 906, depicted in FIG. 9) may receive configuration information associated with a downlink BWP, wherein the configuration information comprises a first configuration or a second configuration, wherein the first configuration configures the UE to receive downlink communications via only SBFD symbols of the downlink BWP or only non-SBFD symbols of the downlink BWP, and wherein the second configuration configures the UE to receive the downlink communications via the SBFD symbols and the non-SBFD symbols, as described above.

As further shown in FIG. 5, in some aspects, process 500 may include receiving the downlink communications via the downlink BWP in accordance with the configuration information, wherein the UE applies the first configuration or the second configuration, or refrains from applying the configuration information to CLI-RSSI measurement resources and SRS-RSRP measurement resources within the downlink BWP, and wherein the UE performs a CLI-RSSI measurement, an SRS-RSRP measurement, or both the CLI-RSSI measurement and the SRS-RSRP measurement based at least in part on a signal transmitted via the SBFD symbols, the non-SBFD symbols, or both the SBFD symbols and the non-SBFD symbols (block 520). For example, the UE (e.g., using reception component 902 or communication manager 906, depicted in FIG. 9) may receive the downlink communications via the downlink BWP in accordance with the configuration information, wherein the UE applies the first configuration or the second configuration, or refrains from applying the configuration information to CLI-RSSI measurement resources and SRS-RSRP measurement resources within the downlink BWP, and wherein the UE performs a CLI-RSSI measurement, an SRS-RSRP measurement, or both the CLI-RSSI measurement and the SRS-RSRP measurement based at least in part on a signal transmitted via the SBFD symbols, the non-SBFD symbols, or both the SBFD symbols and the non-SBFD symbols, as described above.

Process 500 may include additional aspects, such as any single aspect or any combination of aspects described below or in connection with one or more other processes described elsewhere herein.

In a first aspect, the configuration information comprises the first configuration, and the UE receives the downlink communications via only the SBFD symbols of the downlink BWP in accordance with the first configuration, or the UE receives the downlink communications via only the non-SBFD symbols of the downlink BWP in accordance with the first configuration.

In a second aspect, alone or in combination with the first aspect, the UE refrains from reporting an average measured CLI resource value in accordance with the configuration information.

In a third aspect, alone or in combination with one or more of the first and second aspects, a CLI resource is configured across the SBFD symbols and the non-SBFD symbols.

In a fourth aspect, alone or in combination with one or more of the first through third aspects, process 500 includes transmitting a CLI report in accordance with the configuration information, wherein the UE determines that the UE is to receive the downlink communications via only the SBFD symbols of the downlink BWP based at least in part on the UE transmitting the CLI report.

In a fifth aspect, alone or in combination with one or more of the first through fourth aspects, the configuration information includes a field indicating a valid symbol type associated with measuring CLI.

In a sixth aspect, alone or in combination with one or more of the first through fifth aspects, the field includes data indicating that the SBFD symbols correspond to the valid symbol type.

In a seventh aspect, alone or in combination with one or more of the first through sixth aspects, the field is not configured, and the UE determines that the SBFD symbols correspond to the valid symbol type based at least in part on the field not being configured.

In an eighth aspect, alone or in combination with one or more of the first through seventh aspects, the configuration information comprises the first configuration.

In a ninth aspect, alone or in combination with one or more of the first through eighth aspects, the UE refrains from reporting an average measured CLI resource value in accordance with the configuration information.

In a tenth aspect, alone or in combination with one or more of the first through ninth aspects, a CLI resource is configured across the SBFD symbols and the non-SBFD symbols.

In an eleventh aspect, alone or in combination with one or more of the first through tenth aspects, a timeRestrictionForChannelMeasurement parameter is set to configured to indicate that no average of CLI measurement occasions for CLI reporting.

In a twelfth aspect, alone or in combination with one or more of the first through eleventh aspects, receiving the configuration information comprises receiving first configuration information associated with configuring CLI resources, and receiving second configuration information associated with a CLI report.

In a thirteenth aspect, alone or in combination with one or more of the first through twelfth aspects, the configuration information configures a set of resources associated with the SBFD symbols and a set of resources associated with the non-SBFD symbols.

In a fourteenth aspect, alone or in combination with one or more of the first through thirteenth aspects, a valid symbol type associated with the first configuration corresponds to the SBFD symbols.

In a fifteenth aspect, alone or in combination with one or more of the first through fourteenth aspects, a valid symbol type associated with the second configuration corresponds to the non-SBFD symbols.

In a sixteenth aspect, alone or in combination with one or more of the first through fifteenth aspects, the configuration information comprises the second configuration, and process 500 includes transmitting a CLI report indicating a latest measured CLI resource value of a plurality of CLI resource values measured by the UE.

In a seventeenth aspect, alone or in combination with one or more of the first through sixteenth aspects, a CLI resource is configured across the SBFD symbols and the non-SBFD symbols.

In an eighteenth aspect, alone or in combination with one or more of the first through seventeenth aspects, the configuration information comprises the first configuration, wherein the configuration information is absent to indicate whether the UE is to receive the downlink communications via the SBFD symbols or the non-SBFD symbols, and wherein the UE receives the downlink communications via the SBFD symbols based at least in part on the configuration information being absent to indicate whether the UE is to receive the downlink communications via the SBFD symbols or the non-SBFD symbols.

In a nineteenth aspect, alone or in combination with one or more of the first through eighteenth aspects, the configuration information comprises the first configuration, wherein the configuration information is absent to indicate whether the UE is to receive the downlink communications via the SBFD symbols or the non-SBFD symbols, and wherein the UE receives the downlink communications via the non-SBFD symbols based at least in part on the configuration information being absent to indicate whether the UE is to receive the downlink communications via the SBFD symbols or the non-SBFD symbols.

In a twentieth aspect, alone or in combination with one or more of the first through nineteenth aspects, the configuration information comprises the first configuration, wherein the configuration information is associated with CSI reporting, wherein the configuration is absent to indicate whether the CSI reporting is associated with the SBFD symbols or the non-SBFD symbols, and wherein the UE receives the downlink communications via the non-SBFD symbols based at least in part on the configuration information being absent to indicate whether the CSI reporting is associated with the SBFD symbols or the non-SBFD symbols.

In a twenty-first aspect, alone or in combination with one or more of the first through twentieth aspects, the configuration information comprises the first configuration, wherein the configuration information is associated with CSI reporting, wherein the configuration is absent to indicate whether the CSI reporting is associated with the SBFD symbols or the non-SBFD symbols, and wherein the UE is to receive the downlink communications via the SBFD symbols based at least in part on the configuration information being absent to indicate whether the CSI reporting is associated with the SBFD symbols or the non-SBFD symbols.

In a twenty-second aspect, alone or in combination with one or more of the first through twenty-first aspects, all CLI measurement resource occasions are in SBFD symbols, and process 500 includes measuring CLI based at least in part on a signal transmitted via the SBFD symbols, wherein signals transmitted via CLI resources in non-SBFD symbols are not measured.

In a twenty-third aspect, alone or in combination with one or more of the first through twenty-second aspects, CLI measurement resource occasions are in SBFD symbols and non-SBFD symbols, and process 500 includes measuring CLI based at least in part on a signal transmitted via the SBFD symbols, wherein signals transmitted via CLI resources in non-SBFD symbols are not measured, measuring the CLI based at least in part on a signal transmitted via the non-SBFD symbols, wherein signals transmitted via CLI resources in SBFD symbols are not measured, or measuring the CLI based at least in part on signals transmitted via the SBFD symbols and the non-SBFD symbols, wherein the UE refrains from averaging CLI results across the SBFD symbols and the non-SBFD symbols.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a diagram illustrating an example process 600 performed, for example, at a UE or an apparatus of a UE. Example process 600 is an example where the apparatus or the UE (e.g., UE 120) performs operations associated with CLI resource signaling.

As shown in FIG. 6, in some aspects, process 600 may include receiving configuration information associated with a downlink BWP, wherein the BWP includes a set of SBFD symbols and a set of non-SBFD symbols (block 610). For example, the UE (e.g., using reception component 902 or communication manager 906, depicted in FIG. 9) may receive configuration information associated with a downlink BWP, wherein the BWP includes a set of SBFD symbols and a set of non-SBFD symbols, as described above.

As further shown in FIG. 6, in some aspects, process 600 may include communicating via the BWP, wherein communications via the downlink BWP are communicated via the set of SBFD symbols or the set of non-SBFD symbols, wherein the UE performs a CLI-RSSI measurement, an SRS-RSRP measurement, or both the CLI-RSSI measurement and the SRS-RSRP measurement (block 620). For example, the UE (e.g., using reception component 902, transmission component 904, or communication manager 906, depicted in FIG. 9) may communicate via the BWP, wherein communications via the downlink BWP are communicated via the set of SBFD symbols or the set of non-SBFD symbols, wherein the UE performs a CLI-RSSI measurement, an SRS-RSRP measurement, or both the CLI-RSSI measurement and the SRS-RSRP measurement, as described above.

Process 600 may include additional aspects, such as any single aspect or any combination of aspects described below or in connection with one or more other processes described elsewhere herein.

In a first aspect, the UE receives downlink communications via only the set of SBFD symbols in accordance with the configuration information, or the UE receives the downlink communications via only the non-SBFD symbols of the downlink BWP in accordance with the first configuration.

In a second aspect, alone or in combination with the first aspect, the UE refrains from reporting an average measured CLI resource value in accordance with the configuration information.

In a third aspect, alone or in combination with one or more of the first and second aspects, a CLI resource is configured across the set of SBFD symbols and the set of non-SBFD symbols.

In a fourth aspect, alone or in combination with one or more of the first through third aspects, process 600 includes transmitting a CLI report in accordance with the configuration information, wherein the UE receives downlink communications via only the set of SBFD symbols of the BWP based at least in part on transmitting the CLI report.

In a fifth aspect, alone or in combination with one or more of the first through fourth aspects, the configuration information includes a field indicating a valid symbol type associated with measuring CLI.

In a sixth aspect, alone or in combination with one or more of the first through fifth aspects, the field includes data indicating that the set of SBFD symbols correspond to the valid symbol type.

In a seventh aspect, alone or in combination with one or more of the first through sixth aspects, the field is not configured, and the UE determines that the set of SBFD symbols correspond to the valid symbol type based at least in part on the field not being configured.

In an eighth aspect, alone or in combination with one or more of the first through seventh aspects, the UE refrains from reporting an average measured CLI resource value in accordance with the configuration information.

In a ninth aspect, alone or in combination with one or more of the first through eighth aspects, a CLI resource is configured across the set of SBFD symbols and the non-SBFD symbols.

In a tenth aspect, alone or in combination with one or more of the first through ninth aspects, a timeRestrictionForChannelMeasurement parameter is set to configured to indicate that no average of CLI measurement occasions for CLI reporting.

In an eleventh aspect, alone or in combination with one or more of the first through tenth aspects, receiving the configuration information comprises receiving first configuration information associated with configuring CLI resources, and receiving second configuration information associated with a CLI report.

In a twelfth aspect, alone or in combination with one or more of the first through eleventh aspects, the configuration information configures a set of resources associated with the set of SBFD symbols and a set of resources associated with the non-SBFD symbols.

In a thirteenth aspect, alone or in combination with one or more of the first through twelfth aspects, a valid symbol type associated with the first configuration corresponds to the SBFD symbols.

In a fourteenth aspect, alone or in combination with one or more of the first through thirteenth aspects, a valid symbol type associated with the second configuration corresponds to the non-SBFD symbols.

In a fifteenth aspect, alone or in combination with one or more of the first through fourteenth aspects, the configuration information fails to indicate whether the UE is to receive downlink communications via the set of SBFD symbols or the set of non-SBFD symbols, and the UE receives the downlink communications via the SBFD symbols based at least in part on the configuration information failing to indicate whether the UE is to receive the downlink communications via the SBFD symbols or the non-SBFD symbols.

In a sixteenth aspect, alone or in combination with one or more of the first through fifteenth aspects, the configuration information fails to indicate whether the UE is to receive downlink communications via the set of SBFD symbols or the set of non-SBFD symbols, and the UE receives the downlink communications via the set of non-SBFD symbols based at least in part on the configuration information failing to indicate whether the UE is to receive the downlink communications via the set of SBFD symbols or the set of non-SBFD symbols.

In a seventeenth aspect, alone or in combination with one or more of the first through sixteenth aspects, the configuration information is associated with CSI reporting, wherein the configuration is absent to indicate whether the CSI reporting is associated with the set of SBFD symbols or the set of non-SBFD symbols, and wherein the UE receives downlink communications via the set of non-SBFD symbols based at least in part on the configuration information being absent to indicate whether the CSI reporting is associated with the set of SBFD symbols or the set of non-SBFD symbols.

In an eighteenth aspect, alone or in combination with one or more of the first through seventeenth aspects, the configuration information is associated with CSI reporting, wherein the configuration is absent to indicate whether the CSI reporting is associated with the set of SBFD symbols or the set of non-SBFD symbols, and wherein the UE receives downlink communications via the set of SBFD symbols based at least in part on the configuration information being absent to indicate whether the CSI reporting is associated with the set of SBFD symbols or the set of non-SBFD symbols.

In a nineteenth aspect, alone or in combination with one or more of the first through eighteenth aspects, all CLI measurement resource occasions are in SBFD symbols, and process 600 includes measuring CLI based at least in part on a signal transmitted via the SBFD symbols, wherein signals transmitted via CLI resources in non-SBFD symbols are not measured.

In a twentieth aspect, alone or in combination with one or more of the first through nineteenth aspects, CLI measurement resource occasions are in SBFD symbols and non-SBFD symbols, and process 600 includes measuring CLI based at least in part on a signal transmitted via the SBFD symbols, wherein signals transmitted via CLI resources in non-SBFD symbols are not measured, measuring the CLI based at least in part on a signal transmitted via the non-SBFD symbols, wherein signals transmitted via CLI resources in SBFD symbols are not measured, or measuring the CLI based at least in part on signals transmitted via the SBFD symbols and the non-SBFD symbols, wherein the UE refrains from averaging CLI results across the SBFD symbols and the non-SBFD symbols.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, at a network node or an apparatus of a network node. Example process 700 is an example where the apparatus or the network node (e.g., network node 110) performs operations associated with CLI resource signaling.

As shown in FIG. 7, in some aspects, process 700 may include transmitting configuration information associated with a downlink BWP, wherein the configuration information comprises a first configuration or a second configuration, wherein the first configuration configures a UE to receive downlink communications via only SBFD symbols of the downlink BWP or only non-SBFD symbols of the downlink BWP, wherein the second configuration configures the UE to receive the downlink communications via the SBFD symbols and the non-SBFD symbols, and wherein the configuration information configures the UE to refrain from applying the configuration information to CLI-RSSI measurement resources and SRS-RSRP measurement resources within the downlink BWP (block 710). For example, the network node (e.g., using transmission component 1004 or communication manager 1006, depicted in FIG. 10) may transmit configuration information associated with a downlink BWP, wherein the configuration information comprises a first configuration or a second configuration, wherein the first configuration configures a UE to receive downlink communications via only SBFD symbols of the downlink BWP or only non-SBFD symbols of the downlink BWP, wherein the second configuration configures the UE to receive the downlink communications via the SBFD symbols and the non-SBFD symbols, and wherein the configuration information configures the UE to refrain from applying the configuration information to CLI-RSSI measurement resources and SRS-RSRP measurement resources within the downlink BWP, as described above.

As further shown in FIG. 7, in some aspects, process 700 may include transmitting the downlink communications via the downlink BWP in accordance with the configuration information (block 720). For example, the network node (e.g., using transmission component 1004 or communication manager 1006, depicted in FIG. 10) may transmit the downlink communications via the downlink BWP in accordance with the configuration information, as described above.

Process 700 may include additional aspects, such as any single aspect or any combination of aspects described below or in connection with one or more other processes described elsewhere herein.

In a first aspect, the configuration information comprises the first configuration, and the UE receives the downlink communications via only the SBFD symbols of the downlink BWP in accordance with the configuration information, or the UE receives the downlink communications via only the non-SBFD symbols of the downlink BWP in accordance with the first configuration.

In a second aspect, alone or in combination with the first aspect, the UE refrains from reporting an average measured CLI resource value in accordance with the configuration information.

In a third aspect, alone or in combination with one or more of the first and second aspects, a CLI resource is configured across the SBFD symbols and the non-SBFD symbols.

In a fourth aspect, alone or in combination with one or more of the first through third aspects, process 700 includes transmitting a CLI report in accordance with the configuration information, wherein the UE receives the downlink communications via only the SBFD symbols of the downlink BWP based at least in part on the UE transmitting the CLI report.

In a fifth aspect, alone or in combination with one or more of the first through fourth aspects, the configuration information includes a field indicating a valid symbol type associated with measuring CLI.

In a sixth aspect, alone or in combination with one or more of the first through fifth aspects, the field includes data indicating that the SBFD symbols correspond to the valid symbol type.

In a seventh aspect, alone or in combination with one or more of the first through sixth aspects, the field is not configured, and the UE determines that the SBFD symbols correspond to the valid symbol type based at least in part on the field not being configured.

In an eighth aspect, alone or in combination with one or more of the first through seventh aspects, the configuration information comprises the first configuration.

In a ninth aspect, alone or in combination with one or more of the first through eighth aspects, the UE refrains from reporting an average measured CLI resource value in accordance with the configuration information.

In a tenth aspect, alone or in combination with one or more of the first through ninth aspects, a CLI resource is configured across the SBFD symbols and the non-SBFD symbols.

In an eleventh aspect, alone or in combination with one or more of the first through tenth aspects, a timeRestrictionForChannelMeasurement parameter is set to configured to indicate that no average of CLI measurement occasions for CLI reporting.

In a twelfth aspect, alone or in combination with one or more of the first through eleventh aspects, transmitting the configuration information comprises transmitting first configuration information associated with configuring CLI resources, and transmitting second configuration information associated with a CLI report.

In a thirteenth aspect, alone or in combination with one or more of the first through twelfth aspects, the configuration information configures a set of resources associated with the SBFD symbols and a set of resources associated with the non-SBFD symbols.

In a fourteenth aspect, alone or in combination with one or more of the first through thirteenth aspects, a valid symbol type associated with the first configuration corresponds to the SBFD symbols.

In a fifteenth aspect, alone or in combination with one or more of the first through fourteenth aspects, a valid symbol type associated with the second configuration corresponds to the non-SBFD symbols.

In a sixteenth aspect, alone or in combination with one or more of the first through fifteenth aspects, the configuration information comprises the second configuration, and process 700 includes receiving a CLI report indicating a latest measured CLI resource value of a plurality of CLI resource values measured by the UE.

In a seventeenth aspect, alone or in combination with one or more of the first through sixteenth aspects, a CLI resource is configured across the SBFD symbols and the non-SBFD symbols.

In an eighteenth aspect, alone or in combination with one or more of the first through seventeenth aspects, the configuration information comprises the first configuration, wherein the configuration information is absent to indicate whether the UE is to receive the downlink communications via the SBFD symbols or the non-SBFD symbols, and wherein the UE receives the downlink communications via the SBFD symbols based at least in part on the configuration information being absent to indicate whether the UE is configured to receive the downlink communications via the SBFD symbols or the non-SBFD symbols.

In a nineteenth aspect, alone or in combination with one or more of the first through eighteenth aspects, the configuration information comprises the first configuration, wherein the configuration information is absent to indicate whether the UE is to receive the downlink communications via the SBFD symbols or the non-SBFD symbols, and wherein the UE receives the downlink communications via the non-SBFD symbols based at least in part on the configuration information being absent to indicate whether the UE is configured to receive the downlink communications via the SBFD symbols or the non-SBFD symbols.

In a twentieth aspect, alone or in combination with one or more of the first through nineteenth aspects, the configuration information comprises the first configuration, wherein the configuration information is associated with CSI reporting, wherein the configuration is absent to indicate whether the CSI reporting is associated with the SBFD symbols or the non-SBFD symbols, and wherein the UE receives the downlink communications via the non-SBFD symbols based at least in part on the configuration information being absent to indicate whether the CSI reporting is associated with the SBFD symbols or the non-SBFD symbols.

In a twenty-first aspect, alone or in combination with one or more of the first through twentieth aspects, the configuration information comprises the first configuration, wherein the configuration information is associated with CSI reporting, wherein the configuration is absent to indicate whether the CSI reporting is associated with the SBFD symbols or the non-SBFD symbols, and wherein the UE receives the downlink communications via the SBFD symbols based at least in part on the configuration information being absent to indicate whether the CSI reporting is associated with the SBFD symbols or the non-SBFD symbols.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, at a network node or an apparatus of a network node. Example process 800 is an example where the apparatus or the network node (e.g., network node 110) performs operations associated with CLI resource signaling.

As shown in FIG. 8, in some aspects, process 800 may include transmitting configuration information associated with a BWP, wherein the BWP includes a set of SBFD symbols and a set of non-SBFD symbols (block 810). For example, the network node (e.g., using transmission component 1004 or communication manager 1006, depicted in FIG. 10) may transmit configuration information associated with a downlink BWP, wherein the downlink BWP includes a set of SBFD symbols and a set of non-SBFD symbols, as described above.

As further shown in FIG. 8, in some aspects, process 800 may include communicating with a UE via the downlink BWP, wherein communications via the BWP are communicated via the set of SBFD symbols or the set of non-SBFD symbols in accordance with a condition, wherein the condition is not applied to CLI-RSSI measurement resources and SRS-RSRP measurement resources within the downlink BWP (block 820). For example, the network node (e.g., using reception component 1002, transmission component 1004, or communication manager 1006, depicted in FIG. 10) may communicate with a UE via the downlink BWP, wherein communications via the BWP are communicated via the set of SBFD symbols or the set of non-SBFD symbols in accordance with a condition, wherein the condition is not applied to CLI-RSSI measurement resources and SRS-RSRP measurement resources within the downlink BWP, as described above.

Process 800 may include additional aspects, such as any single aspect or any combination of aspects described below or in connection with one or more other processes described elsewhere herein.

In a first aspect, the UE receives downlink communications via only the set of SBFD symbols in accordance with the configuration information, or the UE receives the downlink communications via only the non-SBFD symbols of the downlink BWP in accordance with the first configuration.

In a second aspect, alone or in combination with the first aspect, the UE refrains from reporting an average measured CLI resource value in accordance with the configuration information.

In a third aspect, alone or in combination with one or more of the first and second aspects, a CLI resource is configured across the set of SBFD symbols and the set of non-SBFD symbols.

In a fourth aspect, alone or in combination with one or more of the first through third aspects, process 800 includes receiving a CLI report transmitted by the UE, wherein the UE receives downlink communications via only the set of SBFD symbols of the BWP based at least in part on the UE transmitting the CLI report.

In a fifth aspect, alone or in combination with one or more of the first through fourth aspects, the configuration information includes a field indicating a valid symbol type associated with measuring CLI.

In a sixth aspect, alone or in combination with one or more of the first through fifth aspects, the field includes data indicating that the set of SBFD symbols correspond to the valid symbol type.

In a seventh aspect, alone or in combination with one or more of the first through sixth aspects, the field is not configured to indicate that the set of SBFD symbols correspond to the valid symbol type.

In an eighth aspect, alone or in combination with one or more of the first through seventh aspects, the UE refrains from reporting an average measured CLI resource value in accordance with the configuration information.

In a ninth aspect, alone or in combination with one or more of the first through eighth aspects, a CLI resource is configured across the set of SBFD symbols and the non-SBFD symbols.

In a tenth aspect, alone or in combination with one or more of the first through ninth aspects, a timeRestrictionForChannelMeasurement parameter is set to configured to indicate that no average of CLI measurement occasions for CLI reporting.

In an eleventh aspect, alone or in combination with one or more of the first through tenth aspects, transmitting the configuration information comprises transmitting first configuration information associated with configuring CLI resources, and transmitting second configuration information associated with a CLI report.

In a twelfth aspect, alone or in combination with one or more of the first through eleventh aspects, the configuration information configures a set of resources associated with the set of SBFD symbols and a set of resources associated with the non-SBFD symbols.

In a thirteenth aspect, alone or in combination with one or more of the first through twelfth aspects, the configuration information is absent to indicate whether the UE is to receive downlink communications via the set of SBFD symbols or the set of non-SBFD symbols, and the UE receives the downlink communications via the SBFD symbols based at least in part on the configuration information being absent to indicate whether the UE is to receive the downlink communications via the SBFD symbols or the non-SBFD symbols.

In a fourteenth aspect, alone or in combination with one or more of the first through thirteenth aspects, the configuration information is absent to indicate whether the UE is to receive downlink communications via the set of SBFD symbols or the set of non-SBFD symbols, and the UE receives the downlink communications via the set of non-SBFD symbols based at least in part on the configuration information being absent to indicate whether the UE is to receive the downlink communications via the set of SBFD symbols or the set of non-SBFD symbols.

In a fifteenth aspect, alone or in combination with one or more of the first through fourteenth aspects, the configuration information is associated with CSI reporting, wherein the configuration is absent to indicate whether the CSI reporting is associated with the set of SBFD symbols or the set of non-SBFD symbols, and wherein the UE receives downlink communications via the set of non-SBFD symbols based at least in part on the configuration information being absent to indicate whether the CSI reporting is associated with the set of SBFD symbols or the set of non-SBFD symbols.

In a sixteenth aspect, alone or in combination with one or more of the first through fifteenth aspects, the configuration information is associated with CSI reporting, wherein the configuration is absent to indicate whether the CSI reporting is associated with the set of SBFD symbols or the set of non-SBFD symbols, and wherein the UE receives downlink communications via the set of SBFD symbols based at least in part on the configuration information being absent to indicate whether the CSI reporting is associated with the set of SBFD symbols or the set of non-SBFD symbols.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication. The apparatus 900 may be a UE, or a UE may include the apparatus 900. In some aspects, the apparatus 900 includes a reception component 902, a transmission component 904, or a communication manager 906, which may be in communication with one another (for example, via one or more buses or one or more other components). In some aspects, the communication manager 906 is the communication manager 150 described in connection with FIG. 1. As shown, the apparatus 900 may communicate with another apparatus 908, such as a UE or a network node (such as a CU, a DU, an RU, or a base station), using the reception component 902 and the transmission component 904. The communication manager 906 may be included in, or implemented via, a processing system (for example, the processing system 140 described in connection with FIG. 1) of the UE.

In some aspects, the apparatus 900 may be configured to perform one or more operations described herein in connection with FIGS. 2-4. Additionally, or alternatively, the apparatus 900 may be configured to perform one or more processes described herein, such as process 500 of FIG. 5, process 600 of FIG. 6, or a combination thereof. In some aspects, the apparatus 900 or one or more components shown in FIG. 9 may include one or more components of the UE described in connection with FIG. 1. Additionally, or alternatively, one or more components shown in FIG. 9 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications, and may provide the processed signals to the one or more other components of the apparatus 900. In some aspects, the reception component 902 may include one or more components of the UE described above in connection with FIG. 1, such as a radio, one or more RF chains, one or more transceivers, or one or more modems, each of which may in turn be coupled with one or more antennas of the UE.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications, and may transmit the processed signals to the apparatus 908. In some aspects, the transmission component 904 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 904 may be co-located with the reception component 902.

The communication manager 906 may support operations of the reception component 902 or the transmission component 904. For example, the communication manager 906 may receive information associated with configuring reception of communications by the reception component 902 or transmission of communications by the transmission component 904. Additionally, or alternatively, the communication manager 906 may generate or provide control information to the reception component 902 or the transmission component 904 to control reception or transmission of communications.

The reception component 902 may receive configuration information associated with a downlink BWP, wherein the configuration information comprises a first configuration or a second configuration, wherein the first configuration configures the UE to receive downlink communications via only SBFD symbols of the downlink BWP or only non-SBFD symbols of the downlink BWP, and wherein the second configuration configures the UE to receive the downlink communications via the SBFD symbols and the non-SBFD symbols. The reception component 902 may receive the downlink communications via the downlink BWP in accordance with the configuration information, wherein the UE applies the first configuration or the second configuration, or refrains from applying the configuration information to CLI-RSSI measurement resources and SRS-RSRP measurement resources within the downlink BWP, and wherein the UE performs a CLI-RSSI measurement, an SRS-RSRP measurement, or both the CLI-RSSI measurement and the SRS-RSRP measurement based at least in part on a signal transmitted via the SBFD symbols, the non-SBFD symbols, or both the SBFD symbols and the non-SBFD symbols.

The transmission component 904 may transmit a CLI report in accordance with the configuration information, wherein the UE determines that the UE is to receive the downlink communications via only the SBFD symbols of the downlink BWP based at least in part on the UE transmitting the CLI report.

The reception component 902 may receive configuration information associated with a downlink BWP, wherein the BWP includes a set of SBFD symbols and a set of non-SBFD symbols. The reception component 902 or the transmission component 904 may communicate via the BWP, wherein communications via the downlink BWP are communicated via the set of SBFD symbols or the set of non-SBFD symbols, wherein the UE performs a CLI-RSSI measurement, an SRS-RSRP measurement, or both the CLI-RSSI measurement and the SRS-RSRP measurement.

The transmission component 904 may transmit a CLI report in accordance with the configuration information, wherein the UE receives downlink communications via only the set of SBFD symbols of the BWP based at least in part on transmitting the CLI report.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a diagram of an example apparatus 1000 for wireless communication. The apparatus 1000 may be a network node, or a network node may include the apparatus 1000. In some aspects, the apparatus 1000 includes a reception component 1002, a transmission component 1004, or a communication manager 1006, which may be in communication with one another (for example, via one or more buses or one or more other components). In some aspects, the communication manager 1006 is the communication manager 155 described in connection with FIG. 1. As shown, the apparatus 1000 may communicate with another apparatus 1008, such as a UE or a network node (such as a CU, a DU, an RU, or a base station), using the reception component 1002 and the transmission component 1004. The communication manager 1006 may be included in, or implemented via, a processing system (for example, the processing system 145 described in connection with FIG. 1) of the network node.

In some aspects, the apparatus 1000 may be configured to perform one or more operations described herein in connection with FIGS. 2-4. Additionally, or alternatively, the apparatus 1000 may be configured to perform one or more processes described herein, such as process 700 of FIG. 7, process 800 of FIG. 8, or a combination thereof. In some aspects, the apparatus 1000 or one or more components shown in FIG. 10 may include one or more components of the network node described in connection with FIG. 1. Additionally, or alternatively, one or more components shown in FIG. 10 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications, and may provide the processed signals to the one or more other components of the apparatus 1000. In some aspects, the reception component 1002 may include one or more components of the network node described above in connection with FIG. 1, such as a radio, one or more RF chains, one or more transceivers, or one or more modems, each of which may in turn be coupled with one or more antennas of the network node. In some aspects, the reception component 1002 or the transmission component 1004 may include or may be included in a network interface. The network interface may be configured to obtain or output signals for the apparatus 1000 via one or more communications links, such as a backhaul link, a midhaul link, or a fronthaul link.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications, and may transmit the processed signals to the apparatus 1008. In some aspects, the transmission component 1004 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 1004 may be co-located with the reception component 1002.

The communication manager 1006 may support operations of the reception component 1002 or the transmission component 1004. For example, the communication manager 1006 may receive information associated with configuring reception of communications by the reception component 1002 or transmission of communications by the transmission component 1004. Additionally, or alternatively, the communication manager 1006 may generate or provide control information to the reception component 1002 or the transmission component 1004 to control reception or transmission of communications.

The transmission component 1004 may transmit configuration information associated with a downlink BWP, wherein the configuration information comprises a first configuration or a second configuration, wherein the first configuration configures a UE to receive downlink communications via only SBFD symbols of the downlink BWP or only non-SBFD symbols of the downlink BWP, wherein the second configuration configures the UE to receive the downlink communications via the SBFD symbols and the non-SBFD symbols, and wherein the configuration information configures the UE to refrain from applying the configuration information to CLI-RSSI measurement resources and SRS-RSRP measurement resources within the downlink BWP. The transmission component 1004 may transmit the downlink communications via the downlink BWP in accordance with the configuration information.

The transmission component 1004 may transmit a CLI report in accordance with the configuration information, wherein the UE receives the downlink communications via only the SBFD symbols of the downlink BWP based at least in part on the UE transmitting the CLI report.

The transmission component 1004 may transmit configuration information associated with downlink BWP, wherein the downlink BWP includes a set of SBFD symbols and a set of non-SBFD symbols. The reception component 1002 or the transmission component 1004 may communicate with a UE via the BWP, wherein communications via the BWP are communicated via the set of SBFD symbols or the set of non-SBFD symbols in accordance with a condition, wherein the condition is not applied to CLI-RSSI measurement resources and SRS-RSRP measurement resources within the downlink BWP.

The reception component 1002 may receive a CLI report transmitted by the UE, wherein the UE receives downlink communications via only the set of SBFD symbols of the BWP based at least in part on the UE transmitting the CLI report.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication performed by a UE, comprising: receiving configuration information associated with a downlink BWP, wherein the configuration information comprises a first configuration or a second configuration, wherein the first configuration configures the UE to receive downlink communications via only SBFD symbols of the downlink BWP or only non-SBFD symbols of the downlink BWP, and wherein the second configuration configures the UE to receive the downlink communications via the SBFD symbols and the non-SBFD symbols; and receiving the downlink communications via the downlink BWP in accordance with the configuration information, wherein the UE applies the first configuration, the second configuration, or refrains from applying the configuration information to CLI-RSSI measurement resources and SRS-RSRP measurement resources within the downlink BWP, and wherein the UE performs a CLI-RSSI measurement, an SRS-RSRP measurement, or both the CLI-RSSI measurement and the SRS-RSRP measurement based at least in part on a signal transmitted via the SBFD symbols, non-SBFD symbols, or both the SBFD symbols and the non-SBFD symbols.

Aspect 2: The method of Aspect 1, wherein the configuration information comprises the first configuration, and wherein the UE receives the downlink communications via only the SBFD symbols of the downlink BWP in accordance with the first configuration, or wherein the UE receives the downlink communications via only the non-SBFD symbols of the downlink BWP in accordance with the first configuration.

Aspect 3: The method of any of Aspects 1-2, wherein the UE refrains from reporting an average measured CLI resource value in accordance with the configuration information.

Aspect 4: The method of Aspect 3, wherein a CLI resource is configured across the SBFD symbols and the non-SBFD symbols.

Aspect 5: The method of Aspect 2, further comprising: transmitting a CLI report in accordance with the configuration information, wherein the UE determines that the UE is to receive the downlink communications via only the SBFD symbols of the downlink BWP based at least in part on the UE transmitting the CLI report.

Aspect 6: The method of Aspect 2, wherein the configuration information includes a field indicating a valid symbol type associated with measuring CLI.

Aspect 7: The method of Aspect 6, wherein the field includes data indicating that the SBFD symbols correspond to the valid symbol type.

Aspect 8: The method of Aspect 6, wherein the field is not configured, and wherein the UE determines that the SBFD symbols correspond to the valid symbol type based at least in part on the field not being configured.

Aspect 9: The method of any of Aspects 1-8, wherein the configuration information comprises the first configuration.

Aspect 10: The method of Aspect 9, wherein the UE refrains from reporting an average measured CLI resource value in accordance with the configuration information.

Aspect 11: The method of Aspect 10, wherein a CLI resource is configured across the SBFD symbols and the non-SBFD symbols.

Aspect 12: The method of Aspect 11, wherein a timeRestrictionForChannelMeasurement parameter is set to configured to indicate that no average of CLI measurement occasions for CLI reporting.

Aspect 13: The method of any of Aspects 1-12, wherein receiving the configuration information comprises: receiving first configuration information associated with configuring CLI resources; and receiving second configuration information associated with a CLI report.

Aspect 14: The method of any of Aspects 1-13, wherein the configuration information configures a set of resources associated with the SBFD symbols and a set of resources associated with the non-SBFD symbols.

Aspect 15: The method of any of Aspects 1-14, wherein a valid symbol type associated with the first configuration corresponds to the SBFD symbols.

Aspect 16: The method of any of Aspects 1-15, wherein a valid symbol type associated with the second configuration corresponds to the non-SBFD symbols.

Aspect 17: The method of any of Aspects 1-16, wherein the configuration information comprises the second configuration, the method further comprising: transmitting a CLI report indicating a latest measured CLI resource value of a plurality of CLI resource values measured by the UE.

Aspect 18: The method of Aspect 17, wherein a CLI resource is configured across the SBFD symbols and the non-SBFD symbols.

Aspect 19: The method of any of Aspects 1-18, wherein the configuration information comprises the first configuration, wherein the configuration information is absent to indicate whether the UE is to receive the downlink communications via the SBFD symbols or the non-SBFD symbols, and wherein the UE receives the downlink communications via the SBFD symbols based at least in part on the configuration information being absent to indicate whether the UE is to receive the downlink communications via the SBFD symbols or the non-SBFD symbols.

Aspect 20: The method of any of Aspects 1-19, wherein the configuration information comprises the first configuration, wherein the configuration information is absent to indicate whether the UE is to receive the downlink communications via the SBFD symbols or the non-SBFD symbols, and wherein the UE receives the downlink communications via the non-SBFD symbols based at least in part on the configuration information being absent to indicate whether the UE is to receive the downlink communications via the SBFD symbols or the non-SBFD symbols.

Aspect 21: The method of any of Aspects 1-20, wherein the configuration information comprises the first configuration, wherein the configuration information is associated with CSI reporting, wherein the configuration is absent to indicate whether the CSI reporting is associated with the SBFD symbols or the non-SBFD symbols, and wherein the UE receives the downlink communications via the non-SBFD symbols based at least in part on the configuration information being absent to indicate whether the CSI reporting is associated with the SBFD symbols or the non-SBFD symbols.

Aspect 22: The method of any of Aspects 1-21, wherein the configuration information comprises the first configuration, wherein the configuration information is associated with CSI reporting, wherein the configuration is absent to indicate whether the CSI reporting is associated with the SBFD symbols or the non-SBFD symbols, and wherein the UE is to receive the downlink communications via the SBFD symbols based at least in part on the configuration information being absent to indicate whether the CSI reporting is associated with the SBFD symbols or the non-SBFD symbols.

Aspect 23: The method of any of Aspects 1-22, wherein all CLI measurement resource occasions are in SBFD symbols, the method further comprising: measuring CLI based at least in part on a signal transmitted via the SBFD symbols, wherein signals transmitted via CLI resources in non-SBFD symbols are not measured.

Aspect 24: The method of any of Aspects 1-23, wherein CLI measurement resource occasions are in SBFD symbols and non-SBFD symbols, the method further comprising: measuring CLI based at least in part on a signal transmitted via the SBFD symbols, wherein signals transmitted via CLI resources in non-SBFD symbols are not measured; measuring the CLI based at least in part on a signal transmitted via the non-SBFD symbols, wherein signals transmitted via CLI resources in SBFD symbols are not measured; or measuring the CLI based at least in part on signals transmitted via the SBFD symbols and the non-SBFD symbols, wherein the UE refrains from averaging CLI results across the SBFD symbols and the non-SBFD symbols.

Aspect 25: A method of wireless communication performed by a UE, comprising: receiving configuration information associated with a downlink BWP, wherein the BWP includes a set of SBFD symbols and a set of non-SBFD symbols; and communicating via the BWP, wherein communications via the downlink BWP are communicated via the set of SBFD symbols or the set of non-SBFD symbols, wherein the UE performs a CLI-RSSI measurement, an SRS-RSRP measurement, or both the CLI-RSSI measurement and the SRS-RSRP measurement.

Aspect 26: The method of Aspect 25, wherein the UE receives downlink communications via only the set of SBFD symbols in accordance with the configuration information, or wherein the UE receives the downlink communications via only the non-SBFD symbols of the downlink BWP in accordance with the first configuration.

Aspect 27: The method of any of Aspects 25-26, wherein the UE refrains from reporting an average measured CLI resource value in accordance with the configuration information.

Aspect 28: The method of Aspect 27, wherein a CLI resource is configured across the set of SBFD symbols and the set of non-SBFD symbols.

Aspect 29: The method of any of Aspects 25-28, further comprising: transmitting a CLI report in accordance with the configuration information, wherein the UE receives downlink communications via only the set of SBFD symbols of the BWP based at least in part on transmitting the CLI report.

Aspect 30: The method of any of Aspects 25-29, wherein the configuration information includes a field indicating a valid symbol type associated with measuring CLI.

Aspect 31: The method of Aspect 30, wherein the field includes data indicating that the set of SBFD symbols correspond to the valid symbol type.

Aspect 32: The method of Aspect 30, wherein the field is not configured, and wherein the UE determines that the set of SBFD symbols correspond to the valid symbol type based at least in part on the field not being configured.

Aspect 33: The method of any of Aspects 25-32, wherein the UE refrains from reporting an average measured CLI resource value in accordance with the configuration information.

Aspect 34: The method of Aspect 33, wherein a CLI resource is configured across the set of SBFD symbols and the non-SBFD symbols.

Aspect 35: The method of any of Aspects 25-34, wherein a timeRestrictionForChannelMeasurement parameter is set to configured to indicate that no average of CLI measurement occasions for CLI reporting.

Aspect 36: The method of any of Aspects 25-35, wherein receiving the configuration information comprises: receiving first configuration information associated with configuring CLI resources; and receiving second configuration information associated with a CLI report.

Aspect 37: The method of any of Aspects 25-36, wherein the configuration information configures a set of resources associated with the set of SBFD symbols and a set of resources associated with the non-SBFD symbols.

Aspect 38: The method of any of Aspects 25-37, wherein a valid symbol type associated with the first configuration corresponds to the SBFD symbols.

Aspect 39: The method of any of Aspects 25-38, wherein a valid symbol type associated with the second configuration corresponds to the non-SBFD symbols.

Aspect 40: The method of any of Aspects 25-39, wherein the configuration information fails to indicate whether the UE is to receive downlink communications via the set of SBFD symbols or the set of non-SBFD symbols, and wherein the UE receives the downlink communications via the SBFD symbols based at least in part on the configuration information failing to indicate whether the UE is to receive the downlink communications via the SBFD symbols or the non-SBFD symbols.

Aspect 41: The method of any of Aspects 25-40, wherein the configuration information fails to indicate whether the UE is to receive downlink communications via the set of SBFD symbols or the set of non-SBFD symbols, and wherein the UE receives the downlink communications via the set of non-SBFD symbols based at least in part on the configuration information failing to indicate whether the UE is to receive the downlink communications via the set of SBFD symbols or the set of non-SBFD symbols.

Aspect 42: The method of any of Aspects 25-41, wherein the configuration information is associated with CSI reporting, wherein the configuration is absent to indicate whether the CSI reporting is associated with the set of SBFD symbols or the set of non-SBFD symbols, and wherein the UE receives downlink communications via the set of non-SBFD symbols based at least in part on the configuration information being absent to indicate whether the CSI reporting is associated with the set of SBFD symbols or the set of non-SBFD symbols.

Aspect 43: The method of any of Aspects 25-42, wherein the configuration information is associated with CSI reporting, wherein the configuration is absent to indicate whether the CSI reporting is associated with the set of SBFD symbols or the set of non-SBFD symbols, and wherein the UE receives downlink communications via the set of SBFD symbols based at least in part on the configuration information being absent to indicate whether the CSI reporting is associated with the set of SBFD symbols or the set of non-SBFD symbols.

Aspect 44: The method of any of Aspects 25-43, wherein all CLI measurement resource occasions are in SBFD symbols, the method further comprising: measuring CLI based at least in part on a signal transmitted via the SBFD symbols, wherein signals transmitted via CLI resources in non-SBFD symbols are not measured.

Aspect 45: The method of any of Aspects 25-44, wherein CLI measurement resource occasions are in SBFD symbols and non-SBFD symbols, the method further comprising: measuring CLI based at least in part on a signal transmitted via the SBFD symbols, wherein signals transmitted via CLI resources in non-SBFD symbols are not measured; measuring the CLI based at least in part on a signal transmitted via the non-SBFD symbols, wherein signals transmitted via CLI resources in SBFD symbols are not measured; or measuring the CLI based at least in part on signals transmitted via the SBFD symbols and the non-SBFD symbols, wherein the UE refrains from averaging CLI results across the SBFD symbols and the non-SBFD symbols.

Aspect 46: A method of wireless communication performed by a network node, comprising: transmitting configuration information associated with a downlink BWP, wherein the configuration information comprises a first configuration or a second configuration, wherein the first configuration configures a user equipment (UE) to receive downlink communications via only SBFD symbols of the downlink BWP or only non-SBFD symbols of the downlink BWP, wherein the second configuration configures the UE to receive the downlink communications via the SBFD symbols and the non-SBFD symbols, and wherein the configuration information configures the UE to refrain from applying the configuration information to CLI-RSSI measurement resources and SRS-RSRP measurement resources within the downlink BWP; and transmitting the downlink communications via the downlink BWP in accordance with the configuration information.

Aspect 47: The method of Aspect 46, wherein the configuration information comprises the first configuration, and wherein the UE receives the downlink communications via only the SBFD symbols of the downlink BWP in accordance with the configuration information, or wherein the UE receives the downlink communications via only the non-SBFD symbols of the downlink BWP in accordance with the first configuration.

Aspect 48: The method of any of Aspects 46-47, wherein the UE refrains from reporting an average measured CLI resource value in accordance with the configuration information.

Aspect 49: The method of Aspect 48, wherein a CLI resource is configured across the SBFD symbols and the non-SBFD symbols.

Aspect 50: The method of Aspect 47, further comprising: transmitting a CLI report in accordance with the configuration information, wherein the UE receives the downlink communications via only the SBFD symbols of the downlink BWP based at least in part on the UE transmitting the CLI report.

Aspect 51: The method of Aspect 47, wherein the configuration information includes a field indicating a valid symbol type associated with measuring CLI.

Aspect 52: The method of Aspect 51, wherein the field includes data indicating that the SBFD symbols correspond to the valid symbol type.

Aspect 53: The method of Aspect 51, wherein the field is not configured, and wherein the UE determines that the SBFD symbols correspond to the valid symbol type based at least in part on the field not being configured.

Aspect 54: The method of any of Aspects 46-53, wherein the configuration information comprises the first configuration.

Aspect 55: The method of Aspect 54, wherein the UE refrains from reporting an average measured CLI resource value in accordance with the configuration information.

Aspect 56: The method of Aspect 55, wherein a CLI resource is configured across the SBFD symbols and the non-SBFD symbols.

Aspect 57: The method of any of Aspects 46-56, wherein a timeRestrictionForChannelMeasurement parameter is set to configured to indicate that no average of CLI measurement occasions for CLI reporting.

Aspect 58: The method of any of Aspects 46-57, wherein transmitting the configuration information comprises: transmitting first configuration information associated with configuring CLI resources; and transmitting second configuration information associated with a CLI report.

Aspect 59: The method of any of Aspects 46-58, wherein the configuration information configures a set of resources associated with the SBFD symbols and a set of resources associated with the non-SBFD symbols.

Aspect 60: The method of any of Aspects 46-59, wherein a valid symbol type associated with the first configuration corresponds to the SBFD symbols.

Aspect 61: The method of any of Aspects 46-60, wherein a valid symbol type associated with the second configuration corresponds to the non-SBFD symbols.

Aspect 62: The method of any of Aspects 46-61, wherein the configuration information comprises the second configuration, the method further comprising: receiving a CLI report indicating a latest measured CLI resource value of a plurality of CLI resource values measured by the UE.

Aspect 63: The method of Aspect 59, wherein a CLI resource is configured across the SBFD symbols and the non-SBFD symbols.

Aspect 64: The method of any of Aspects 46-63, wherein the configuration information comprises the first configuration, wherein the configuration information is absent to indicate whether the UE is to receive the downlink communications via the SBFD symbols or the non-SBFD symbols, and wherein the UE receives the downlink communications via the SBFD symbols based at least in part on the configuration information being absent to indicate whether the UE is configured to receive the downlink communications via the SBFD symbols or the non-SBFD symbols.

Aspect 65: The method of any of Aspects 46-64, wherein the configuration information comprises the first configuration, wherein the configuration information is absent to indicate whether the UE is to receive the downlink communications via the SBFD symbols or the non-SBFD symbols, and wherein the UE receives the downlink communications via the non-SBFD symbols based at least in part on the configuration information being absent to indicate whether the UE is configured to receive the downlink communications via the SBFD symbols or the non-SBFD symbols.

Aspect 66: The method of any of Aspects 46-65, wherein the configuration information comprises the first configuration, wherein the configuration information is associated with CSI reporting, wherein the configuration is absent to indicate whether the CSI reporting is associated with the SBFD symbols or the non-SBFD symbols, and wherein the UE receives the downlink communications via the non-SBFD symbols based at least in part on the configuration information being absent to indicate whether the CSI reporting is associated with the SBFD symbols or the non-SBFD symbols.

Aspect 67: The method of any of Aspects 46-66, wherein the configuration information comprises the first configuration, wherein the configuration information is associated with CSI reporting, wherein the configuration is absent to indicate whether the CSI reporting is associated with the SBFD symbols or the non-SBFD symbols, and wherein the UE receives the downlink communications via the SBFD symbols based at least in part on the configuration information being absent to indicate whether the CSI reporting is associated with the SBFD symbols or the non-SBFD symbols.

Aspect 68: A method of wireless communication performed by a network node, comprising: transmitting configuration information associated with a BWP, wherein the BWP includes a set of SBFD symbols and a set of non-SBFD symbols; and communicating with a UE via the BWP, wherein communications via the BWP are communicated via the set of SBFD symbols or the set of non-SBFD symbols in accordance with a condition, wherein the condition is not applied to CLI-RSSI measurement resources and SRS-RSRP measurement resources within the downlink BWP.

Aspect 69: The method of Aspect 68, wherein the UE receives downlink communications via only the set of SBFD symbols in accordance with the configuration information, or wherein the UE receives the downlink communications via only the non-SBFD symbols of the downlink BWP in accordance with the first configuration.

Aspect 70: The method of any of Aspects 68-69, wherein the UE refrains from reporting an average measured CLI resource value in accordance with the configuration information.

Aspect 71: The method of Aspect 70, wherein a CLI resource is configured across the set of SBFD symbols and the set of non-SBFD symbols.

Aspect 72: The method of any of Aspects 68-71, further comprising: receiving a CLI report transmitted by the UE, wherein the UE receives downlink communications via only the set of SBFD symbols of the BWP based at least in part on the UE transmitting the CLI report.

Aspect 73: The method of any of Aspects 68-72, wherein the configuration information includes a field indicating a valid symbol type associated with measuring CLI.

Aspect 74: The method of Aspect 73, wherein the field includes data indicating that the set of SBFD symbols correspond to the valid symbol type.

Aspect 75: The method of Aspect 73, wherein the field is not configured to indicate that the set of SBFD symbols correspond to the valid symbol type.

Aspect 76: The method of any of Aspects 68-75, wherein the UE refrains from reporting an average measured CLI resource value in accordance with the configuration information.

Aspect 77: The method of Aspect 76, wherein a CLI resource is configured across the set of SBFD symbols and the non-SBFD symbols.

Aspect 78: The method of any of Aspects 68-77, wherein a timeRestrictionForChannelMeasurement parameter is set to configured to indicate that no average of CLI measurement occasions for CLI reporting.

Aspect 79: The method of any of Aspects 68-78, wherein transmitting the configuration information comprises: transmitting first configuration information associated with configuring CLI resources; and transmitting second configuration information associated with a CLI report.

Aspect 80: The method of any of Aspects 68-79, wherein the configuration information configures a set of resources associated with the set of SBFD symbols and a set of resources associated with the non-SBFD symbols.

Aspect 81: The method of any of Aspects 68-80, wherein the configuration information is absent to indicate whether the UE is to receive downlink communications via the set of SBFD symbols or the set of non-SBFD symbols, and wherein the UE receives the downlink communications via the SBFD symbols based at least in part on the configuration information being absent to indicate whether the UE is to receive the downlink communications via the SBFD symbols or the non-SBFD symbols.

Aspect 82: The method of any of Aspects 68-81, wherein the configuration information is absent to indicate whether the UE is to receive downlink communications via the set of SBFD symbols or the set of non-SBFD symbols, and wherein the UE receives the downlink communications via the set of non-SBFD symbols based at least in part on the configuration information being absent to indicate whether the UE is to receive the downlink communications via the set of SBFD symbols or the set of non-SBFD symbols.

Aspect 83: The method of any of Aspects 68-82, wherein the configuration information is associated with CSI reporting, wherein the configuration is absent to indicate whether the CSI reporting is associated with the set of SBFD symbols or the set of non-SBFD symbols, and wherein the UE receives downlink communications via the set of non-SBFD symbols based at least in part on the configuration information being absent to indicate whether the CSI reporting is associated with the set of SBFD symbols or the set of non-SBFD symbols.

Aspect 84: The method of any of Aspects 68-83, wherein the configuration information is associated with CSI reporting, wherein the configuration is absent to indicate whether the CSI reporting is associated with the set of SBFD symbols or the set of non-SBFD symbols, and wherein the UE receives downlink communications via the set of SBFD symbols based at least in part on the configuration information being absent to indicate whether the CSI reporting is associated with the set of SBFD symbols or the set of non-SBFD symbols.

Aspect 85: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-84.

Aspect 86: An apparatus for wireless communication at a device, the apparatus comprising one or more memories and one or more processors coupled to the one or more memories, the one or more processors configured to cause the device to perform the method of one or more of Aspects 1-84.

Aspect 87: An apparatus for wireless communication, the apparatus comprising at least one means for performing the method of one or more of Aspects 1-84.

Aspect 88: A non-transitory computer-readable medium storing code for wireless communication, the code comprising instructions executable by one or more processors to perform the method of one or more of Aspects 1-84.

Aspect 89: A non-transitory computer-readable medium storing a set of instructions for wireless communication, the set of instructions comprising one or more instructions that, when executed by one or more processors of a device, cause the device to perform the method of one or more of Aspects 1-84.

Aspect 90: A device for wireless communication, the device comprising a processing system that includes one or more processors and one or more memories coupled with the one or more processors, the processing system configured to cause the device to perform the method of one or more of Aspects 1-84.

Aspect 91: An apparatus for wireless communication at a device, the apparatus comprising one or more memories and one or more processors coupled to the one or more memories, the one or more processors individually or collectively configured to cause the device to perform the method of one or more of Aspects 1-84.

Aspect 92: A device comprising a processing system that includes one or more processors and one or more code-storing memories coupled with the one or more processors, the processing system configured to cause the device to perform the method of one or more of Aspects 1-84.

Aspect 93: A device comprising a processing system that includes processor circuitry and code-storing memory circuitry, the processing system configured to cause the device to perform the method of one or more of Aspects 1-84.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of′ or “one or more of′ a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,“ ” or the equivalent in context, whatever it is that is “associated with ‘a,” may be associated with “a” alone or associated with a combination of “a” and one or more other conditions, factors, criteria, elements, components, or actions, among other examples. In various examples, the phrase “associated with” may be interpreted to mean “in association with,” “in accordance with,” “based on,” “based at least in part on,” “as a function of,” “in response to,” “responsive to,” or “using” as appropriate in the relevant context unless otherwise explicitly indicated. Furthermore, what follows the phrase “associated with,” “in association with,” “in accordance with,” “based on,” “based at least in part on,” “as a function of,” “in response to,” “responsive to,” or “using” is not necessarily the focal point or primary factor associated with the limitation preceding the phrase.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE), comprising:
a processing system that includes one or more processors and one or more code-storing memories coupled with the one or more processors, the processing system configured to cause the UE to:
receive configuration information associated with a downlink bandwidth part (BWP), wherein the configuration information comprises a first configuration or a second configuration, wherein the first configuration configures the UE to receive downlink communications via only sub-band full duplex (SBFD) symbols of the downlink BWP or only non-SBFD symbols of the downlink BWP, and wherein the second configuration configures the UE to receive the downlink communications via the SBFD symbols and the non-SBFD symbols; and
receive the downlink communications via the downlink BWP in accordance with the configuration information,
wherein the UE applies the first configuration or the second configuration or refrains from applying the configuration information to cross link interference received signal strength indicator (CLI-RSSI) measurement resources and sounding reference signal reference signal received power (SRS-RSRP) measurement resources within the downlink BWP, and
wherein the UE performs a CLI-RSSI measurement, an SRS-RSRP measurement, or both the CLI-RSSI measurement and the SRS-RSRP measurement based at least in part on a signal transmitted via the SBFD symbols, non-SBFD symbols, or both the SBFD symbols and the non-SBFD symbols.

2. The UE of claim 1, wherein the configuration information comprises the first configuration, and wherein the UE receives the downlink communications via only the SBFD symbols of the downlink BWP in accordance with the first configuration, or wherein the UE receives the downlink communications via only the non-SBFD symbols of the downlink BWP in accordance with the first configuration.

3. The UE of claim 1, wherein the UE refrains from reporting an average measured CLI resource value in accordance with the configuration information.

4. The UE of claim 3, wherein a CLI resource is configured across the SBFD symbols and the non-SBFD symbols.

5. The UE of claim 2, wherein the processing system is configured to cause the UE to:
transmit a CLI report in accordance with the configuration information, wherein the UE determines that the UE is to receive the downlink communications via only the SBFD symbols of the downlink BWP based at least in part on the UE transmitting the CLI report.

6. The UE of claim 2, wherein the configuration information includes a field indicating a valid symbol type associated with measuring CLI.

7. The UE of claim 6, wherein the field includes data indicating that the SBFD symbols correspond to the valid symbol type.

8. The UE of claim 6, wherein the field is not configured, and wherein the UE determines that the SBFD symbols correspond to the valid symbol type based at least in part on the field not being configured.

9. The UE of claim 1, wherein the configuration information comprises the first configuration.

10. The UE of claim 9, wherein the UE refrains from reporting an average measured CLI resource value in accordance with the configuration information.

11. The UE of claim 10, wherein a CLI resource is configured across the SBFD symbols and the non-SBFD symbols.

12. The UE of claim 11, wherein a timeRestrictionForChannelMeasurement parameter is set to configured to indicate that no average of CLI measurement occasions for CLI reporting.

13. The UE of claim 1, wherein the processing system, to cause the UE to receive the configuration information, is configured to cause the UE to:
receive first configuration information associated with configuring CLI resources; and
receive second configuration information associated with a CLI report.

14. The UE of claim 1, wherein the configuration information configures a set of resources associated with the SBFD symbols and a set of resources associated with the non-SBFD symbols.

15. The UE of claim 1, wherein a valid symbol type associated with the first configuration corresponds to the SBFD symbols.

16. The UE of claim 1, wherein a valid symbol type associated with the second configuration corresponds to the non-SBFD symbols.

17. The UE of claim 1, wherein the configuration information comprises the second configuration, the processing system further configured to cause the UE to:
transmit a CLI report indicating a latest measured CLI resource value of a plurality of CLI resource values measured by the UE.

18. The UE of claim 17, wherein a CLI resource is configured across the SBFD symbols and the non-SBFD symbols.

19. A user equipment (UE), comprising:
a processing system that includes one or more processors and one or more code-storing memories coupled with the one or more processors, the processing system configured to cause the UE to:
receive configuration information associated with a downlink bandwidth part (BWP), wherein the downlink BWP includes a set of sub-band full duplex (SBFD) symbols and a set of non-SBFD symbols; and
communicate via the downlink BWP, wherein communications via the downlink BWP are communicated via the set of SBFD symbols or the set of non-SBFD symbols, wherein the UE performs a cross link interference received signal strength indicator (CLI-RSSI) measurement, a sounding reference signal reference signal received power (SRS-RSRP) measurement, or both the CLI-RSSI measurement and the SRS-RSRP measurement.

20. A method of wireless communication performed by a user equipment (UE), comprising:
receiving configuration information associated with a downlink bandwidth part (BWP), wherein the configuration information comprises a first configuration or a second configuration, wherein the first configuration configures the UE to receive downlink communications via only sub-band full duplex (SBFD) symbols of the downlink BWP or only non-SBFD symbols of the downlink BWP, and wherein the second configuration configures the UE to receive the downlink communications via the SBFD symbols and the non-SBFD symbols; and
receiving the downlink communications via the downlink BWP in accordance with the configuration information,
wherein the UE applies the first configuration, the second configuration, or refrains from applying the configuration information to cross link interference received signal strength indicator (CLI-RSSI) measurement resources and sounding reference signal reference signal received power (SRS-RSRP) measurement resources within the downlink BWP, and
wherein the UE performs a CLI-RSSI measurement, an SRS-RSRP measurement, or both the CLI-RSSI measurement and the SRS-RSRP measurement based at least in part on a signal transmitted via the SBFD symbols, non-SBFD symbols, or both the SBFD symbols and the non-SBFD symbols.
